(19) United States
(12) Patent Application Publication
(10) Pub. No.: US 2013/0063610 A1
(43) Pub. Date: Mar. 14, 2013

(54) Electronic Camera Comprising Means for Navigating and Printing Image Data

(71) Applicant: Nikon Corporation, Tokyo (JP)

(72) Inventor: Akira OHMURA, Kawasaki-shi (JP)

(73) Assignee: NIKON CORPORATION, Tokyo (JP)

(21) Appl. No.: 13/667,422

(22) Filed: Nov. 2, 2012

Related U.S. Application Data
(63) Continuation of application No. 12/591,449, filed on Nov. 19, 2009, now abandoned.
Application No. 12/591,449 is a continuation of application No. 11/438,276, filed on May 23, 2006, now abandoned.
Application No. 11/438,276 is a continuation of application No. 10/128,243, filed on Apr. 24, 2002, now abandoned.
Application No. 10/128,243 is a continuation of application No. 09/841,999, filed on Apr. 26, 2001, now abandoned.
Application No. 09/841,999 is a continuation of application No. 09/184,717, filed on Nov. 3, 1998, now abandoned.

(30) Foreign Application Priority Data
Nov. 5, 1997 (JP) 09302555

(51) Int. Cl. H04N 5/225

(52) U.S. Cl. 348/207.2; 348/207.99; 348/E05.024

(57) ABSTRACT

An image is shot by an electronic camera using a convenient operation. Shot images are recorded into a directory corresponding to a user by shooting date and/or event. When a print-out mode is selected, a plurality of thumbnail images are displayed on the camera display, and when a single click is made by an undepicted pen on a specified thumbnail image, the display color of the thumbnail image is changed. Furthermore, when another click is subsequently made, the display color of all the thumbnail images included in the same event as that of the first designated thumbnail image is changed. Subsequently, when another click is made, the display color of all the thumbnail images of the same shooting date is changed, and when another click is subsequently made, the display color of all the thumbnail images included in the same directory is changed. Furthermore, on a specified display screen, when an execution key is pressed, the thumbnail images of which the display color is changed are printed.

### INCORPORATION BY REFERENCE

This is a Continuation of application Ser. No. 12/591,449 filed Nov. 19, 2009, which in turn is a Continuation of application Ser. No. 11/438,276 filed May 23, 2006, which in turn is a Continuation of application Ser. No. 10/128,243 filed Apr. 24, 2002, which in turn is a Continuation of application Ser. No. 09/841,999 filed Apr. 26, 2001, which in turn is a Continuation of application Ser. No. 09/184,717 filed Nov. 3, 1998. The disclosure of each of the prior applications is hereby incorporated by reference herein in its entirety.

The disclosure of the following priority application is herein incorporated by reference: Japanese Patent Application No. 9-302555, filed Nov. 5, 1997.

### BACKGROUND OF THE INVENTION

1. Field of Invention

The present invention relates to an information processing device and method, and to a recording medium that stores an information processing control program. In particular, it relates to an information processing device, method and program that are used with an external printer and capable of printing out a shot image.

2. Description of Related Art

In a conventional electronic camera, when printing a shot (photographed) image using a printer or the like, the images to be printed are designated one by one from among an image group (a group of images) stored in a memory or the like, and the corresponding data is output in the designated order to the printer. However, in the conventional electronic camera, when printing out the shot images, the mutual relationship of each image is not considered. Accordingly, when the user wishes to print a group of images that are photographed at a certain event (for example, a picnic or the like), there is a problem that the operation becomes complicated because it is necessary for the user to designate and to print out all the images belonging to that event one by one.

Additionally, a conventional electronic camera does not have a way to distinguish images that have already been printed out from images that have not yet been printed out. Therefore, there is the problem that the user has to distinguish these images (for example, by comparing the printed images with those stored in memory to determine which have and have not been printed).

Additionally, when the user continuously prints out a plurality of images, once the printing has started, since processing proceeds continuously, there is the problem that the cancellation of unnecessary image(s) cannot be performed during printing.

### SUMMARY OF THE INVENTION

The present invention has been made in consideration of the above-mentioned conditions. According to one aspect of the invention, when using a printer to print images (or otherwise outputting images) that have been shot by an electronic camera, the printing (or other output) is performed in consideration of the mutual relationships of each image, and/or differentiates between images that have already been printed and images that have not yet been printed. Additionally, or alternatively, when performing continuous printing, a camera according to one aspect of the invention can cancel the printout of unnecessary images.

### BRIEF DESCRIPTION OF THE DRAWINGS

The invention will be described in conjunction with the following drawings in which like reference numerals designate like elements and wherein:

FIG. 1 is a perspective front view of an embodiment of an electronic camera according to the present invention;

FIG. 2 is a perspective rear view of the FIG. 1 electronic camera;

FIG. 3 is a perspective rear view of the FIG. 1 electronic camera in a state where an LCD cover is closed;

FIG. 4 is a perspective view showing an internal structure of the electronic camera of FIGS. 1-3;

FIGS. 5A-5C are side views showing the relationship between the position of the LCD cover and the state of the power switch and the LCD switch in the camera of FIGS. 1-3;

FIG. 6 is a block diagram showing the electrical structure of the internal portion of the electronic camera shown in FIGS. 1-3;

FIG. 7 is a diagram explaining the thinning processing of the pixels during the L mode;

FIG. 8 is a diagram explaining the thinning processing of the pixels during the H mode;

FIG. 9 shows an example of the display screen of the electronic camera shown in FIGS. 1-3;

FIG. 10 shows the case when the electronic camera shown in FIG. 1 is connected to a printer;

FIG. 11 is a block diagram of the printer shown in FIG. 10;

FIG. 12 is a flow chart explaining one example of printing processing executed in the electronic camera;

FIG. 13 is a diagram showing a display example of the menu screen;

FIG. 14 is a flow chart explaining details of the display processing of FIG. 12;

FIG. 15 is a diagram explaining one example of images that are recorded in the memory card of the electronic camera;

FIG. 16 is a display example of a screen displayed on the camera LCD when the processing shown in FIG. 12 is executed;

FIG. 17 is a display example of a screen displayed when the touch tablet is single-clicked on the screen shown in FIG. 16;

FIG. 18 is a display example of a screen displayed when the touch tablet is single-clicked on the screen shown in FIG. 17;

FIG. 19 is a display example of a screen displayed when the touch tablet is single-clicked on the screen shown in FIG. 18;

FIG. 20 is a display example of a screen displayed when the touch tablet is single-clicked on the screen shown in FIG. 19;

FIG. 21 is a display example of a screen displayed when the touch tablet is single-clicked on the screen shown in FIG. 20;

FIG. 22 is a flow chart explaining details of the printing processing of FIG. 12;

FIG. 23 is a flow chart explaining details of the index printing processing of FIG. 22;

FIG. 24 is a display example of a screen displayed on the camera LCD when the processing shown in FIG. 12 is executed;

FIG. 25 is a diagram showing a printing example when the image shown in FIG. 23 is printed on recording paper;

FIG. 26 is another display example of a screen displayed on the camera LCD when the processing shown in FIG. 12 is executed;

FIG. 27 is a diagram showing a printing example of index printing;

FIG. 28 is a diagram showing another display example to which the present invention is applied;

FIG. 29 is a display example of a screen displayed when a single click is made on the display screen of FIG. 28;

FIG. 30 is a display example of a screen displayed when a single click is made on the display screen of FIG. 29; and

FIG. 31 is a display example of a screen displayed when a single click is made on the display screen of FIG. 30.

### DETAILED DESCRIPTION OF PREFERRED EMBODIMENTS

Hereafter, embodiments of the present invention are explained with reference to the drawings.

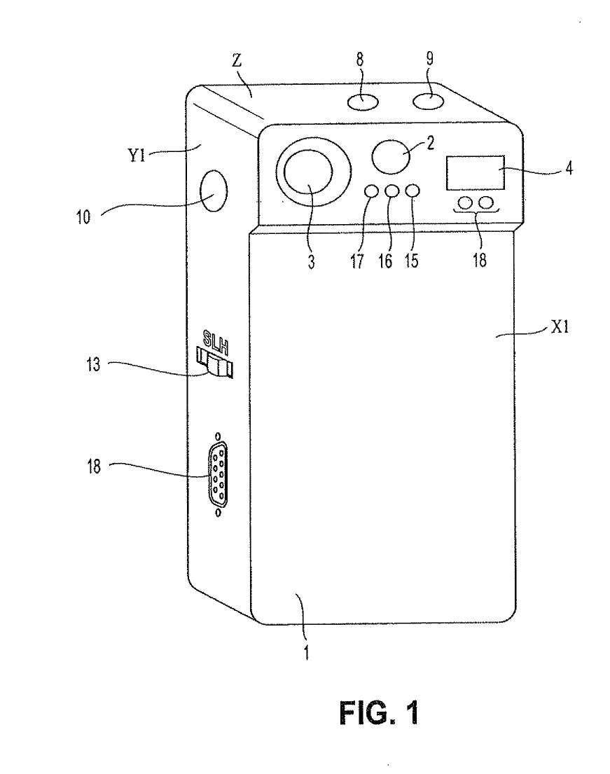

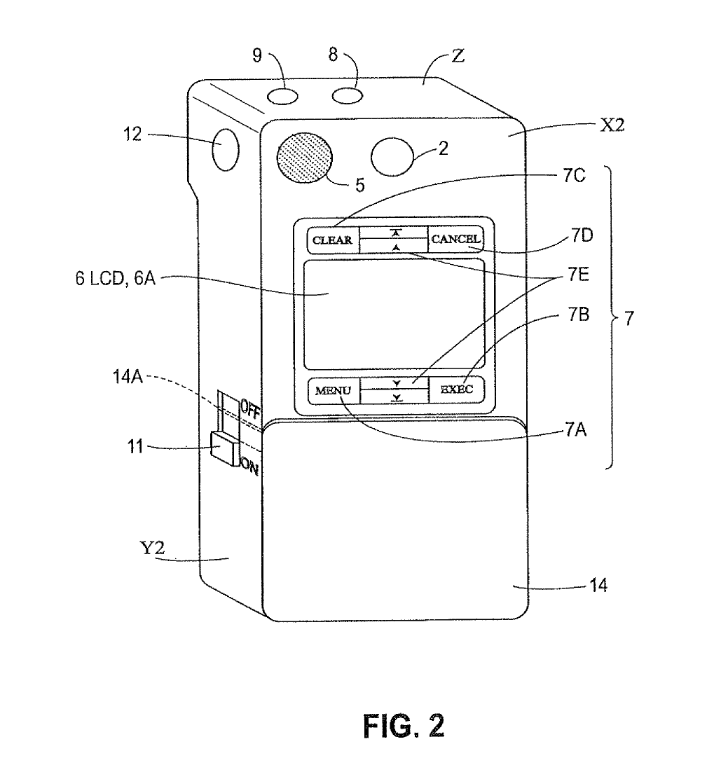

FIGS. 1 and 2 are perspective views that show a structural example of an embodiment of an electronic camera according to the present invention. In the electronic camera of the present embodiment, when shooting an object, the surface facing an object is face X1, and the surface facing the user is face X2. On the top part of the face X1 are provided a viewfinder 2 that is used for the confirmation of the shooting range of the object, a shooting lens 3 that takes-in the optical image of the object, and a light emission part (strobe) 4 to irradiate light that illuminates the object (when needed).

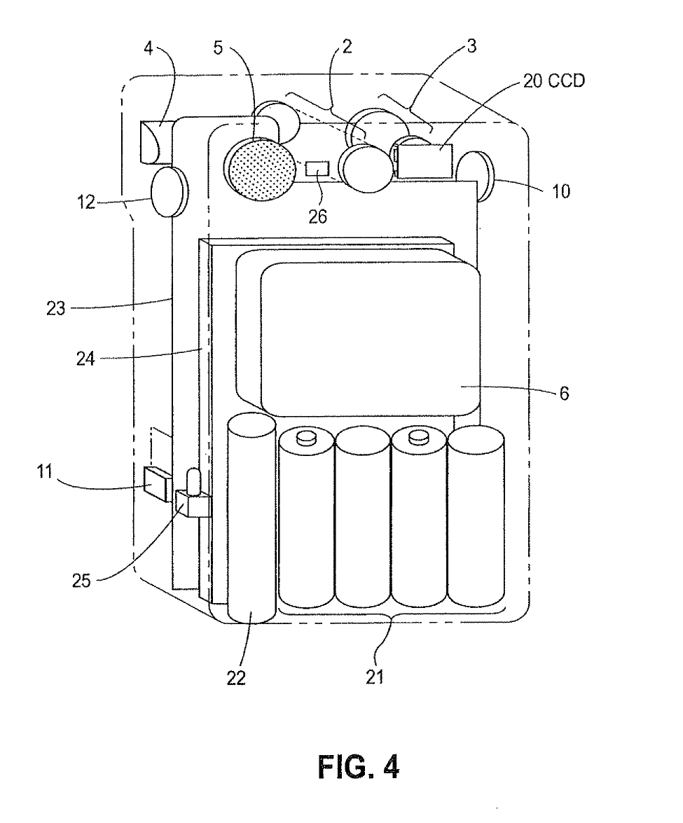

Additionally, in the face X1 are provided a red-eye reduction lamp 15, a photometry element 16 and a colorimetry element 17. The red-eye reduction lamp 15 reduces the red eye phenomenon by emitting light before the light emission of the strobe 4 when shooting is to be performed with the strobe 4. The photometry element 16 performs photometry while the operation of the CCD 20 (FIG. 4) is stopped. The colorimetry element 17 performs colorimetry while the operation of the CCD 20 is stopped.

On the top part of the face X2, opposed to the face X1 (the position corresponding to the top part of the face X1 in which the viewfinder 2, the shooting lens 3 and the light emission part 4 are formed), the above-mentioned viewfinder 2 and a speaker 5 that outputs sound that is recorded in electronic camera 1 are provided. Additionally, an LCD 6 and operation keys 7 are formed on the face X2 vertically lower than the viewfinder 2, the shooting lens 3, the light emission part 4 and the speaker 5. On the surface of the LCD 6, a so called touch tablet 6A (which functions at least in part as, for example, designating means, shifting means and selecting means) is arranged that outputs the position data corresponding to a position designated by the touching operation of, e.g., a later-mentioned pen-type designating device.

Touch tablet 6A is made from a transparent material such as glass, resin or the like. Thus, the user can observe, through the touch tablet 6A, an image that is displayed on the LCD 6 formed below the touch tablet 6A.

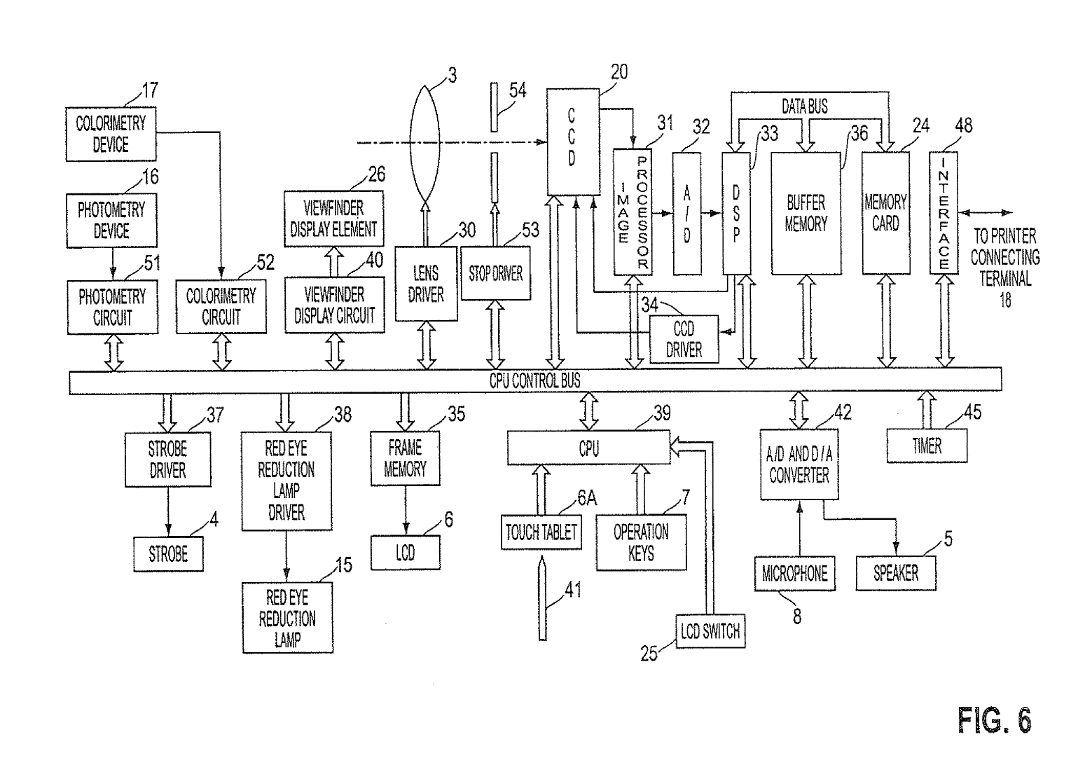

The operation keys 7 are keys to be operated when replaying and displaying the recorded data on the LCD 6, or the like. They detect the operation (input) by a user and supply it to CPU 39 (FIG. 6; which functions at least in part as, for example, stopping means, adding means, read-out means, and setting means). The menu key 7A, among the operation keys 7, is a key to be operated to display the menu screen on the LCD 6. The execution key 7B (which functions at least in part as, for example, selecting means) is a key to be operated to replay the recorded information selected by the user. The clear key 7C is a key to be operated to delete recorded information. The cancel key 7D is a key to be operated to suspend the replay processing of the recorded information. The scroll key 7E is a key to be operated to scroll the screen in the vertical direction when the list of the recorded information is displayed on the LCD 6.

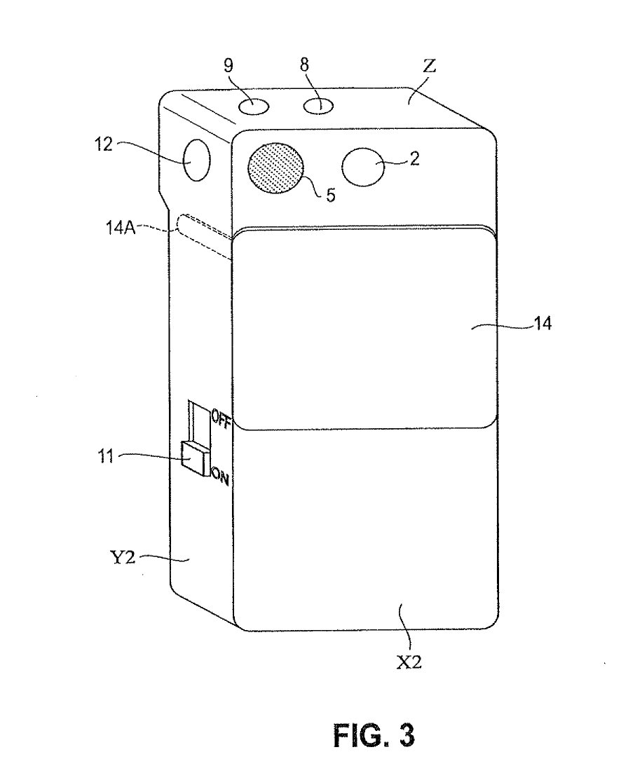

On the face X2, a slidable LCD cover 14 is provided that protects the LCD 6 when it is not used. The LCD cover 14 covers the LCD 6 and the touch tablet 6A when it is shifted to the upper position as shown in FIG. 3. When the LCD cover 14 is shifted to the lower position, the LCD 6 and the touch tablet 6A appear, and a power switch 11 (later-mentioned) that is arranged on the face Y2 is switched to the ON condition by the arm member 14A of the LCD cover 14.

On the face Z, which is the top face of the electronic camera 1, are provided a microphone 8 that collects sound and an earphone jack 9 to which an earphone, not shown in the figure, is connected.

On the left side face Y1 are provided a release switch 10, a continuous mode switch 13 and a printer connecting terminal 18. The release switch 10 is operated when shooting the object. The continuous mode switch 13 is operated when switching to the continuous mode at the time of shooting. The printer connecting terminal 18 is for connecting the electronic camera 1 to an external printer. The release switch 10, continuous mode switch 13 and printer connecting terminal 18 are arranged vertically below the viewfinder 2, the shooting lens 3 and light emission part 4, provided at the top end of the face X1.

On the face Y2 (the right side face) that opposes the face Y1 are provided a recording switch 12, that is operated when recording sound, and a power switch 11. The recording switch 12 and power switch 11 are arranged vertically below the viewfinder 2, the shooting lens 3 and light emission part 4, provided on the top end of the face X1, in a similar manner as the above-mentioned release switch 10 and continuous mode switch 13. Preferably, the recording switch 12 is formed at approximately the same height as the release switch 10 of the face Y1, and it is structured so that the user does not sense a difference, no matter whether he or she holds the camera by the left hand or the right hand.

Alternatively, it is possible to arrange the position of the recording switch 12 so that it is different from the position of the release switch 10 so that when the user presses one of the switches, when the user holds the opposite side face of the camera with a finger in order to cancel the moment induced by this pressure, the user does not accidentally press the switch that is provided on the other side face.

The above-mentioned continuous shooting mode switch 13 is used when setting whether an object is shot for only one frame (single shot) or shot for a specified plurality of frames (continuous shooting) when the user shoots the object by pressing the release switch 10. For example, when the indicator of the continuous mode switch 13 is moved to the position “S” (in other words, it is switched to the S mode), when the release switch 10 is pressed, shooting is performed for only one frame. When the indicator of the continuous mode switch 13 is moved to the position “L” (in other words, it is switched to the L mode), when the release switch 10 is pressed, shooting of 8 frames per second is performed during the period when the release switch 10 is pressed (in other words, it is placed in a low speed continuous shooting mode). Furthermore, when the indicator of the continuous mode switch 13 is moved to the position “H” (in other words, it is switched to the H mode), when the release switch 10 is pressed, shooting of 30 frames per second is performed during the period when the release switch 10 is pressed (in other words, it is placed in a high speed continuous shooting mode).

Next, the internal structure of the electronic camera 1 is explained. FIG. 4 shows a structural example of the inside of the electronic camera shown in FIGS. 1 and 2. A CCD 20 is provided at the rear side (face X2 side) of the shooting lens 3. CCD 20 is a photoelectric converter in that it photoelectrically converts the light image of an object that is imaged-formed via the shooting lens 3 into an electrical signal. Some other possible photoelectric converters include, e.g., a photo-sensitive diode (PSD) and CMOS devices.

An in-finder display element 26 is arranged in the field of view of the viewfinder 2, and displays the setting conditions of various kinds of functions to the user viewing an object through the viewfinder 2.

Below the LCD 6, four cylinder-shaped batteries (AAA dry cell batteries) 21 are vertically aligned. The electric power that is stored in the batteries 21 is supplied to each part of the camera. Additionally, below the LCD 6 is arranged a condenser 22 that accumulates a charge in order to cause the light emission part 4 to emit light.

On a circuit board 23, various control circuits are formed that control each part of the electronic camera 1. Additionally, between the circuit board 23 and the LCD 6 and batteries 21, a memory card 24 is detachably provided. Various kinds of information that are input to the electronic camera 1 are recorded respectively in predetermined areas of the memory card 24.

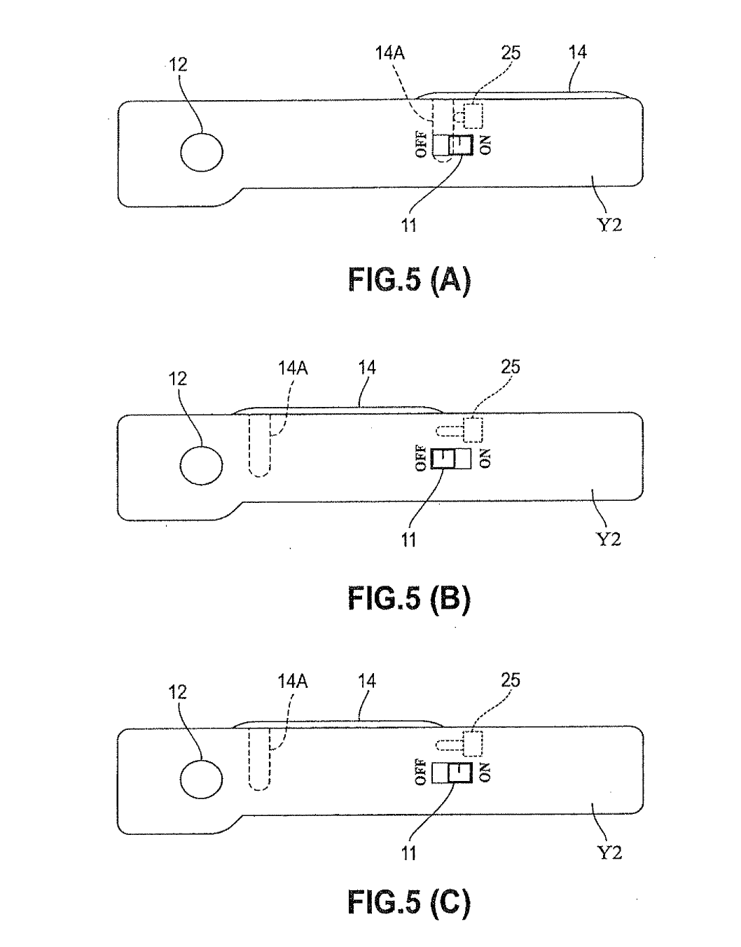

An LCD switch 25 that is arranged adjacent to the power switch 11 is a switch that is placed in the ON condition only while its plunger is pressed. This occurs when the LCD cover 14 is shifted downward, as shown in FIG. 5A. LCD switch 25 is switched to the ON condition along with the power switch 11 by the arm member 14a of the LCD cover 14.

When the LCD cover 14 is positioned in the upper position, the power switch 11 can be operated by the user independent of the LCD switch 25. For example, as shown in FIG. 5B, when the LCD cover 14 is closed and the electronic camera 1 is not being used, the power switch 11 and the LCD switch 25 are in the OFF condition. In this condition, when the user switches the power switch 11 to the ON condition as shown in FIG. 5C, the power switch 11 is placed in the ON condition, however the LCD switch 25 stays in the OFF condition. Meanwhile, when the power switch 11 and the LCD switch 25 are in the OFF condition as shown in FIG. 5B, when the LCD cover 14 is open, as shown in FIG. 5A, the power switch 11 and the LCD switch 25 are placed in the ON condition. Then, after this, when the LCD cover 14 is closed, only the LCD switch 25 is placed in the OFF condition as shown in FIG. 5C.

In the present embodiment, the memory card 24 is detachable. However, it is also acceptable to provide a memory on the circuit board 23 and make it possible to record various kinds of information in the memory. Additionally, it is acceptable to output various kinds of information that are recorded in the memory (memory card 24) to an external personal computer via an interface 48.

Next, the internal structure of the electronic camera 1 of the present embodiment is explained with reference to the block diagram of FIG. 6. The CCD 20, which comprises a plurality of pixels, photoelectrically converts a light image that is image-formed on each pixel into an image signal (electric signal). The digital signal processor (hereafter DSP) 33 supplies a CCD horizontal driving pulse to the CCD 20, controls the CCD driving circuit (CCD driver) 34, and also supplies a CCD vertical driving pulse to the CCD 20.

An image processor 31 is controlled by the CPU 39, and samples the image signal that is electrically converted by the CCD 20 at a predetermined timing, and amplifies the sampled signal to a specified level. The analog/digital converting circuit (hereafter A/D converter) 32 digitizes the image signal that is sampled at the image processor 31, and supplies it to the DSP 33.

The DSP 33 controls a data bus that is connected to the buffer memory 36 and to the memory card 24. After storing the image data that is supplied from the A/D converter 32 to the buffer memory 36, the DSP 33 reads out image data stored in the buffer memory 36 and records the image data to the memory card 24. Additionally, the DSP 33 stores the image data that is supplied from the A/D converter 32 in the frame memory 35 (which functions at least in part as, for example, first and second output means), displays it on the LCD 6, and reads out the shot image data from the memory card 24. After decompressing the shot image data, the DSP 33 stores the decompressed image data in the frame memory 35 and displays it on the LCD 6.

When the electronic camera 1 is active the DSP 33 repeatedly operates the CCD 20 while adjusting the exposure time (exposure value) until the exposure level of the CCD 20 reaches an appropriate value. At this time, it is also acceptable for the DSP 33 to operate the photometry circuit 51 at first, and to calculate the initial value of the exposure time of the CCD 20 according to the light receiving level that is detected by the photometry element 16. By doing this, the adjustment of the exposure time of the CCD 20 can be performed in a short period.

In addition to these operations, the DSP 33 performs timing control of data input/output when recording to the memory card 24, when storing decompressed image data in the buffer memory 36, and the like.

The buffer memory 36 is used to accommodate the difference between the speed of data input/output of the memory card 24 and the processing speed of the CPU 39 and the DSP 33.

The microphone 8 inputs sound information (collects sound) and supplies that sound information to the A/D and D/A converter 42. The A/D and D/A converter 42, after converting the analog signal that corresponds to the sound detected by the microphone 8 into a digital signal, outputs the digital signal to the CPU 39. The A/D and D/A converter 42 also analyzes digital sound data that is supplied from the CPU 39 and outputs an analog sound signal to the speaker 5.

The photometry element 16 measures the light amount of the object and its surroundings, and outputs the measurement result to the photometry circuit 51. The photometry circuit 51, after performing a specified processing to the analog signal that is the photometric result supplied from the photometry element 16, converts it into a digital signal and outputs the digital signal to the CPU 39.

The colorimetry element 17 measures the color temperature of the object and its surroundings, and outputs the measurement result to the colorimetry circuit 52. The colorimetry circuit 52, after performing a specified processing to the analog signal that is the colorimetry result supplied from the colorimetry element 17, converts it into a digital signal and outputs the digital signal to the CPU 39.

The timer 45 has a built-in clock circuit, and outputs data that corresponds to the current time to the CPU 39.

A stop driver 53 sets the aperture diameter of the stop 54 to a specified value. The stop 54 is arranged between the shooting lens 3 and the CCD 20, and changes the aperture of the incident light from the shooting lens 3 to the CCD 20.

The CPU 39 stops the operation of the photometry circuit 51 and the colorimetry circuit 52 when the LCD cover 14 is opened in response to the signal from the LCD switch 25, and, when the LCD cover 14 is closed, operates the photometry circuit 51 and the colorimetry circuit 52 and also stops the operation of the CCD 20 (for example, the electronic shutter operation) until the release switch 10 is placed in the half-pressed condition (the condition in which a first operation is performed). The CPU 39 controls the photometry circuit 51 and the colorimetry circuit 52 when the operation of the CCD 20 is stopped, and receives the photometry result of the photometry element 16 and also receives the colorimetry result of the colorimetry element 17. Then, the CPU 39 calculates the white balance adjustment value that corresponds to the color temperature supplied from the colorimetry circuit 52 with reference to a specified table, and supplies the while balance adjustment value to the image processor 31. In other words, when the LCD cover 14 is closed, the LCD 6 is not used as an electronic viewfinder and therefore the operation of the CCD 20 is stopped. The CCD 20 consumes a large amount of electric power. Therefore, electric power of the battery 21 can be saved by suspending the operation of the CCD 20 as described above.

Additionally, the CPU 39 controls the image processor 31 when the LCD cover 14 is closed so that the image processor 31 does not perform various kinds of processing until the release switch 10 is operated (until the release switch 10 is placed in the half-pressed condition). Additionally, the CPU 39 controls the stop driver 53 when the LCD cover 14 is closed so that the stop driver 53 does not perform the operation of the change in the aperture diameter of the stop 54 or the like until the release switch 10 is operated (until the release switch 10 is placed in the half-pressed condition).

The CPU 39 controls the red-eye reduction lamp driver 38 and makes the red-eye reduction lamp 15 emit the appropriate amount of light before the strobe 4 is emitted. The CPU 39 also controls the strobe driving circuit 37 and makes the strobe 4 emit the appropriate amount of light. Additionally, when the LCD cover 14 is opened (in other words, when the electronic viewfinder is used) the CPU 39 makes the strobe 4 not emit light. By doing this, the object can be photographed in the condition of the image displayed in the electronic viewfinder.

The CPU 39 records the shooting date as header information of the image data in the image recording area of the memory card 24 in accordance with the date data supplied from the timer 45. In other words, the data of the shooting date is attached to (associated with) the shot image data recorded in the shooting image recording area of the memory card 24. Such header information also can be associated with its image data by pointers, for example. Additionally, the CPU 39, after compressing the digitized sound information, stores the digitized and compressed sound data temporarily in the buffer memory 36, and then records it in a specified area (sound recording area) of the memory card 24. Additionally, at this time, the data of the recording date is recorded as header information of the sound data in the sound recording area of the memory card 24.

The CPU 39 performs the auto-focus operation by controlling the lens driving circuit (lens driver) 30 and shifting the shooting lens 3. The CPU 39 also controls the stop driver 53 and changes the aperture diameter of the stop 54 arranged between the shooting lens 3 and the CCD 20. Furthermore, the CPU 39 controls the in-finder display circuit 40 and makes the in-finder display element 26 display the setting of the various operations or the like.

The CPU 39 performs sending and receiving of specified data to/from a specified external device (for example, the later-mentioned printer) via the interface (I/F) 48 (which functions at least in part as, for example, output means, first output means and second output means). Additionally, the CPU 39 receives signals from the operation keys 7 and appropriately processes them.

When a specified position of the touch tablet 6A is pressed by a pen (pen-type designating member) 41 that is operated by the user, the CPU 39 reads out the X-Y coordinates of the first partition of the touch tablet 6A, and accumulates the coordinate data (later-mentioned line drawing information) into the buffer memory 36. Additionally, the CPU 39 records the line drawing information stored in the buffer memory 36 into the line drawing information memory of the memory card 24 along with header information of the line drawing information input date.

Next, various operations of the electronic camera 1 of the present embodiment are explained. First, the electronic viewfinder operation of the LCD 6 of the present device is explained. When the user half-presses the release switch 10, the DSP 33 determines whether the LCD cover 14 is opened from the value of the signal that corresponds to the condition of the LCD switch 25 supplied from the CPU 39. When it determines that the LCD cover 14 is closed, DSP 33 does not perform the electronic viewfinder operation. In this case, the DSP 33 suspends processing until the release switch 10 is operated.

Additionally, when the LCD cover 14 is closed, since the electronic viewfinder operation is not performed, the CPU 39 suspends operation of the CCD 20, the image processor 31 and the stop driver 53. Then, the CPU 39 operates the photometry circuit 51 and the colorimetry circuit 52 instead of operating the CCD 20, and supplies these measurement results to the image processor 31. The image processor 31 uses the values of these measurement results when performing the white balance control and control of the luminance value. When the release switch 10 is operated, the CPU 39 performs the operation of the CCD 20 and the stop driver 53.

On the other hand, when the LCD cover 14 is opened, the CCD 20 performs the electronic shutter operation at a specified exposure amount per specified time period, photoelectrically converts the optical image of the object that is light collected by the shooting lens 3, and outputs the image signal obtained by the operation to the image processor 31. The image processor 31 performs the white balance control and control of the luminance value, and after performing a specified processing to the image signal, outputs the image signal to the A/D converter 32. Additionally, when the CCD 20 is operated, the image processor 31 uses an adjustment value that is used for the white balance control and the luminance value control calculated by the CPU 39 using the output of the CCD 20. Then, the A/D converter 32 converts the image signal (analog signal) into image data (a digital signal), and outputs the image data to the DSP 33. The DSP 33 outputs the image data to the frame memory 35, and displays the image that corresponds to the image data on the LCD 6.

Thus, when the LCD cover 14 is opened, the CCD 20 performs the electronic shutter operation at a specified time interval, converts the signal output from the CCD 20 each time into image data, outputs the image data to the frame memory 35, and displays the image of the object constantly on the LCD 6. The electronic viewfinder operation is thus performed in the electronic camera 1. Additionally, as described above, when the LCD cover 14 is closed, the electronic viewfinder operation is not performed, the operation of the CCD 20, the image processor 31 and the stop driver 53 are suspended, and the consumption of electric power is saved.

Next, the shooting of an object by the present device is explained. First, the case is explained in which the continuous mode switch 13 provided on the face Y1 is switched to the S mode (the mode that performs shooting for only one frame). First, the power of the electronic camera 1 is turned on by switching the power switch 11 shown in FIG. 1 to the side at which “ON” is printed. The object is confirmed by the user in the viewfinder 2, the release switch 10 provided on the face Y1 is pressed, and the shooting processing of the object is started.

Additionally, when the LCD cover 14 is closed, the CPU 39 restarts the operation of the CCD 20, the image processor 31 and the stop driver 53 when the release switch 10 is placed in the half-pressed condition, and starts the shooting processing of the object when the release switch 10 is placed in the full-pressed condition (the condition in which a second operation is performed).

The optical image of the object observed by the viewfinder 2 is light collected by the shooting lens 3, and is image-formed on the CCD 20, which comprises a plurality of pixels. The optical image of the object that is image-formed on the CCD 20 is photoelectrically converted into an image signal at each pixel, and sampled by the image processor 31. The image signal sampled by the image processor 31 is supplied to the A/D converter 32, digitized and output to the DSP 33.

The DSP 33, after temporarily outputting the image data to the buffer memory 36, reads out the image data from the buffer memory 36, compresses it in accordance with, e.g., the JPEG (Joint Photographic Experts Group) method, which is a combination of discrete cosine transformation, quantization and Huffman encoding, and records it in the shot image recording area of the memory card 24. At this time, in the shot image recording area of the memory card 24, the data of the shooting date also is recorded as header information of the shot image data.

Additionally, when the continuous shooting mode switch 13 is switched to the S mode, shooting of only one frame is performed, and even if the release switch 10 is continuously pressed (i.e., held down continuously), no shooting is performed after one frame. When the release switch 10 is continuously pressed, the shot image is displayed on the LCD 6 when the LCD cover 14 is opened.

Next, the case will be described in which the continuous mode switch 13 is switched to the L mode (the mode that performs continuous shooting of 8 frames per second). When the power switch 11 is switched to the side on which is printed “ON” and the release switch 10 provided on the face Y1 is pressed, the shooting processing of the object is started. Additionally, when the LCD cover 14 is closed, the CPU 39 restarts the operation of the CCD 20, the image processor 31 and the stop driver 53 when the release switch 10 is placed in the half-pressed condition, and the shooting processing of the object is started when the release switch 10 is placed in the full-pressed condition.

The optical image of the object observed by the user in the viewfinder 2 is light-collected by the shooting lens 3, and image-formed on the CCD 20. The optical image of the object that is image-formed on the CCD 20 is photoelectrically converted into an image signal at each pixel of the CCD 20, and sampled at a rate of 8 times per second by the image processor 31. Additionally, at this time, the image processor 31 thins out ¾ of the pixels among the image signals of all the pixels of the CCD 20.

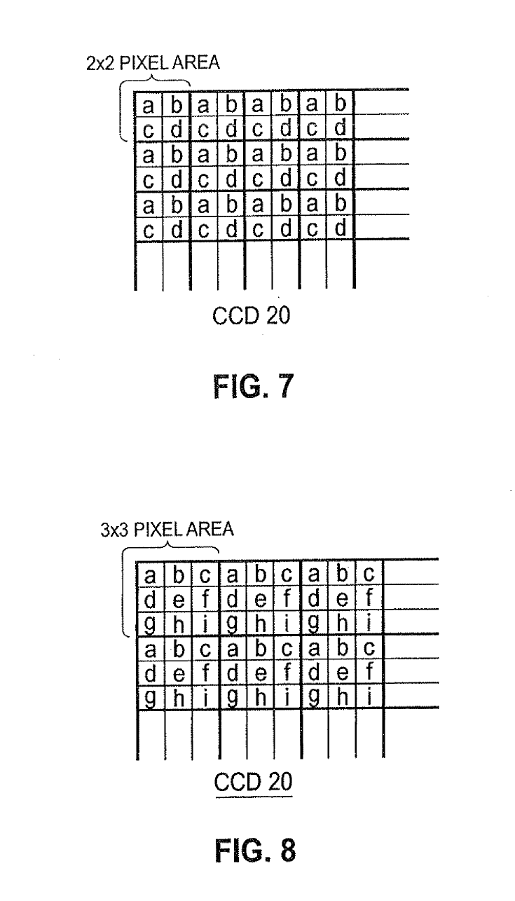

In other words, as shown in FIG. 7, the image processor 31 divides the pixels of the CCD 20 that are arranged in a matrix shape into areas each having 2×2 pixels (4 pixels), samples the image signal of one pixel arranged in a specified position from each area, and thins out (ignores) the remaining three pixels. For example, at the first sampling cycle (first frame), the pixel “a” at the top left corner of each area is sampled, and the other pixels “b”, “c” and “d” are thinned out. At the second sampling cycle (second frame), the pixel “b” at the top right corner of each area is sampled, and the other pixels “a”, “c” and “d” are thinned out. Hereafter, at the third and fourth sampling cycles, the pixel “c” at the bottom left and the pixel “d” at the bottom right are sampled, respectively, and the other pixels are thinned out. In other words, each pixel is sampled once for every four frames.

The image signals sampled by the image processor 31 (the image signals of ¼ of all the pixels of the CCD 20) are supplied to the A/D converter 32, digitized and output to the DSP 33. The DSP 33 reads out the image signals after temporarily outputting the digitized image signal to the buffer memory 36, and after compressing it in accordance with the PEG method, for example, records the shot image data that is digitized and compressed to the shot image recording area of the memory card 24. At this time, in the shot image recording area of the memory card 24, the data of the shooting date also is recorded as header information of the shot image data.

The case is now described in which the continuous shooting mode switch 13 is switched to the H mode (a mode that performs continuous shooting of 30 frames per second). When the power of the electronic camera 1 is turned on by switching the power switch 11 to the side printed “ON” and the release switch 10 provided in the face Y1 is pressed, the shooting processing of the object is started.

Additionally, when the LCD cover 14 is closed, the CPU 39 restarts the operation of the CCD 20, the image processor 31 and stop driver 53 when the release switch 10 is placed in the half-pressed condition, and the shooting processing of the object is started when the release switch 10 is placed in the full-pressed condition.

The optical image of the object observed by the user in the viewfinder 2 is light-collected by the shooting lens 3 and image-formed on the CCD 20. The optical image of the object that is image-formed on the CCD 20 is photoelectrically converted into an image signal at each pixel of the CCD 20, and is sampled at the rate of 30 times per second by the image processor 31. Additionally, at this time, the image processor 31 thins out 8/9 of pixels among the image signal of all the pixels of the CCD 20.

In other words, the image processor 31, as shown in FIG. 8, divides the pixels of the CCD 20, that are arranged in a matrix shape, into areas each having 3×3 pixels (9 pixels), and the image electric signal of one pixel arranged in a specified position in each area is sampled at a rate of thirty times per second, and the remaining 8 pixels are thinned out.

For example, in the first sampling cycle (first frame), pixel “a” at the left top of each area is sampled, and the other pixels “b” through “i” are thinned out. At the second sampling cycle (second frame) the pixel “b” arranged to the right of the pixel “a” is sampled and the other pixels “a” and “c” through “i” are thinned out. Thereafter, at the third and following sampling cycles, pixel “c”, pixel “d” . . . are sampled, respectively, and the other pixels are thinned-out. In other words, each pixel is sampled once every 9 frames.

The image signals that are sampled by the image processor 31 (the image signals of 1/9 of all the pixels of the CCD 20) are supplied to the A/D converter 32, and there digitized and output to the DSP 33. The DSP 33 reads out the image signal after temporarily outputting the digitized image signal to the buffer memory 36, and after the image signal is compressed in accordance with the MEG method, the shot image data that is digitized and compressed is recorded in the shot image recording area of the memory card 24 with header information of the shooting date attached.

Additionally, depending on the necessity, it is possible to operate the strobe 4 and irradiate light onto the object. However, when the LCD cover 14 is opened, in other words, when the LCD 6 is performing the electronic viewfinder operation, the CPU 39 preferably controls the strobe 4 to not emit light.

Next, the operation is described in which two-dimensional information (pen input information) is input by the touch tablet 6A. When the touch tablet 6A is pressed with tip of the pen 41, the X-Y coordinates of the point where the pen contacted is input to the CPU 39. These X-Y coordinates are stored in the buffer memory 36. Additionally, it is possible to write the data corresponding to each point of the above-mentioned X-Y coordinates in the frame memory 35, to display line drawings that correspond to the contact of the pen 41 on the above-mentioned X-Y coordinates on the LCD 6.

As described above, since the touch tablet 6A is a transparent member, the user can observe the point displayed on the LCD 6 (the point of the position pressed by the tip of the pen 41), and can feel as if he or she were performing a direct pen input on the LCD 6. Additionally, when the pen 41 is shifted on the touch tablet 6A, a line is displayed on the LCD 6 in accordance with the movement of the pen 41. Furthermore, when the pen 41 is intermittently shifted on the touch tablet 6A, a broken line that follows the movement of the pen 41 is displayed on the LCD 6. As described above, the user inputs line drawing information of desired characters, drawings or the like on the touch tablet 6A (LCD 6).

Additionally, when a shot image is displayed on the LCD 6, when line drawing information is input by the pen 41, this line drawing information is combined with the shot image information in the frame memory 35 and simultaneously displayed on the LCD 6.

Additionally, the user can select the color of the line drawing displayed on the LCD 6 from among black, white, red, blue or the like by operating a color selection switch, not shown in the figures.

After inputting line drawing information to the touch tablet 6A by the pen 41, when the execution key 7B of the operation keys 7 is pressed, the line drawing information that is accumulated in the buffer memory 36 is supplied to the memory card 24 along with header information of the input date, and is recorded in the line drawing information recording area of the memory card 24.

Additionally, the line drawing information recorded in the memory card 24 is information to which the compression processing preferably has been performed. Since the line drawing information input by the touch tablet 6A contains much information in which the spatial frequency component is high, when the compression processing is performed by the JPEG method, used for compression of the above-mentioned shot image, the compression efficiency is poor, the information amount is not reduced, and the time that is necessary for the compression and decompression becomes long. Additionally, compression by the JPEG method is non-reversible (lossy) compression, and therefore is not suitable for the compression of line drawing information, which has small information amounts (because gathering and smearing) are emphasized in accordance with the lack of information when it is decompressed and displayed on the LCD 6.

Therefore, in the present embodiment, the line drawing information preferably is compressed by the run-length method, which is used for fax machines or the like. The run-length method is a method used to compress line drawing information by scanning the line drawing screen in a horizontal direction and encoding the length over which the information (dots) of each color of black, white, red, blue or the like continues, and the length over which non-information (the portions at which there is no pen input) continues. By using this run length method, the line drawing information can be compressed to a minimum amount. Additionally, even when the compressed line drawing information is decompressed, information deficiencies can be suppressed. Additionally, it is also possible to not compress the line drawing information when its information amount is relatively small.

Furthermore, as described above, when the shot image is displayed on the LCD 6, if pen input is performed, the shot image data and the line drawing information of the pen input are combined in the frame memory 35 and the combined image of the shot image and line drawing is displayed on the LCD 6. Meanwhile, in the memory card 24, the shot image data is recorded in the shot image recording area, and the line drawing information is recorded in the line drawing image information recording area. Because two pieces of information are thus recorded in the respective areas, the user can delete either of the images (e.g., the line drawing) from the combined image of the shot image and the line drawing, and can also compress the respective image information by individual (different) compression methods.

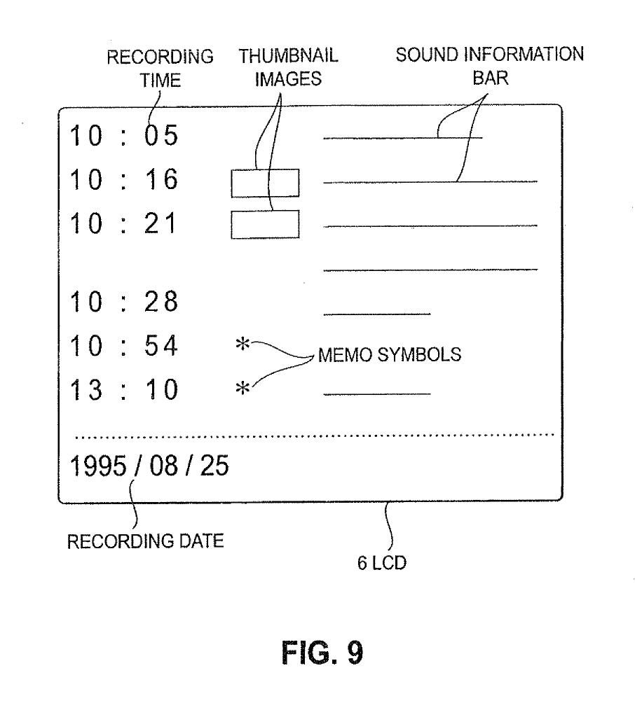

When data is recorded in the sound recording area, the shot image recording area, or the line drawing information recording area of the memory card 24, as shown in FIG. 9, a specified message is displayed on the LCD 6. On the display screen of the LCD 6 shown in FIG. 9, the recording date on which the information is recorded (recording date) is displayed at the base of the screen (in this case, Aug. 25, 1995). The recording times of the information recorded on the recording date are displayed at the far left on the screen.

To the right of the recording times, thumbnail images are displayed when there is shot image information. The thumbnail images are created by thinning out (reducing) the bit map of each image data of the shot image data recorded on the memory card 24. An entry with this kind of display (i.e., a thumbnail image) is an entry including shot image information. That is, the information recorded (input) at “10:16” and “10:21” contains shot image information, and the information recorded at “10:05”, “10:28”, “10:54” and “13:10” does not contain image information. Furthermore, the memo symbol “*” indicates that a specified memo is recorded as line drawing data information. To the right of the thumbnail image display area, a sound information bar is displayed. The length of the bar (line) corresponds to the length of the recording time (when no sound information is input, no line is displayed).

The user presses any part of the display line of the desired information on the LCD 6 shown in FIG. 9 with the tip of the pen 41 to designate the information to be reproduced. By pressing the execution key 7B shown in FIG. 2 with the tip of the pen 41, the designated information is selected and then reproduced. For example, when the line on which “10:05” shown in FIG. 9 is displayed is pressed by the pen 41 (and then the key 7B is pressed), CPU 39 reads the sound data corresponding to the selected recording time and date (10:05) from the memory card 24. After the sound data is decompressed, it is supplied to the A/D and D/A converter 42. After the supplied sound data is converted to analog in the A/D and D/A converter 42, the data is reproduced through the speaker 5.

When the shot image data that has been recorded in the memory card 24 is to be reproduced, the user can designate the information by pressing the desired thumbnail image with the tip of the pen 41 and pressing the execution key 7B to select the designated information to be reproduced. CPU 39 instructs DSP 33 to read out the shot image data corresponding to the selected shooting time and date from the memory card 24. DSP 33 decompresses the shot image data (compressed shot image data) read from the memory card 24, stores this shot image data in the frame memory 35 as bit map data, and displays it on the LCD 6.

An image that was shot in the S mode is displayed as a still image on the LCD 6. Needless to say, this still image is an image in which the image signals of all the pixels of the CCD 20 are reproduced. An image that was shot in the L mode is continually displayed (e.g., as a moving picture) at the rate of 8 frames per second on the LCD 6. At this time, the number of pixels that are displayed in each frame is ¼ of the number of the entire pixels of the CCD 20. Usually, human eyes sensitively respond to the deterioration of the resolution of the still image, so the user will perceive the image as being deteriorated in image quality if the pixels of the still image are thinned out. However, when the continuous shooting speed is increased by shooting 8 frames per second in the L mode, and the image is reproduced at the rate of 8 frames per second, the number of pixels per frame becomes ¼ of the number of pixels of the CCD 20. However, because human eyes observe 8 frames of images per second, the amount of information that enters the human eyes per second becomes double (¼ pixels×8 frames/sec.) compared to the case of the still image.

That is, when the number of pixels of one frame of the image that has been shot in the S mode is 1, the number of pixels of one frame of the image that has been shot in the L mode is ¼. When the image (still image) that was shot in the S mode is displayed on the LCD 6, the information amount that enters the human eyes per second is 1(=(number of pixels 1)×(number of frames 1)). Meanwhile, when the image that has been shot by the L mode is displayed on the LCD 6, the information amount that enters the human eyes per second is 2(=(number of pixels ¼)×(number of frames 8)). That is, double the amount of information of the still image enters the human eyes. Therefore, even if the number of pixels in one frame is ¼, the user can observe the reproduced image without noticing the deterioration of the image quality during the reproduction.

Furthermore, in the present embodiment, because the pixels that vary depending upon each frame are sampled and the sampled pixels are displayed on the LCD 6, the residual image effect occurs in the human eyes. Even if ¾ of the pixels per frame are thinned out, the user can observe the image that has been shot in the L mode displayed on the LCD 6 without noticing the deterioration of the image quality.

Additionally, an image that was shot in the H mode is continually displayed at the rate of 30 frames per second on the LCD 6. At this time, the number of pixels that are displayed per frame is 1/9 of the number of the pixels of the CCD 20, but the user can observe the image that has been shot by the H mode displayed on the LCD 6 without noticing the deterioration of the image quality because of the same reason as for the L mode.

In the present embodiment, when objects are shot in the L mode and the H mode, the image processor 31 thins out pixels of the CCD 20 to a degree where the user does not notice the deterioration of the image quality during the reproduction, so the load of the DSP 33 can be decreased and the DSP 33 can be operated at low speed and low power. Furthermore, because of this, low cost and low power consumption of the device are possible.

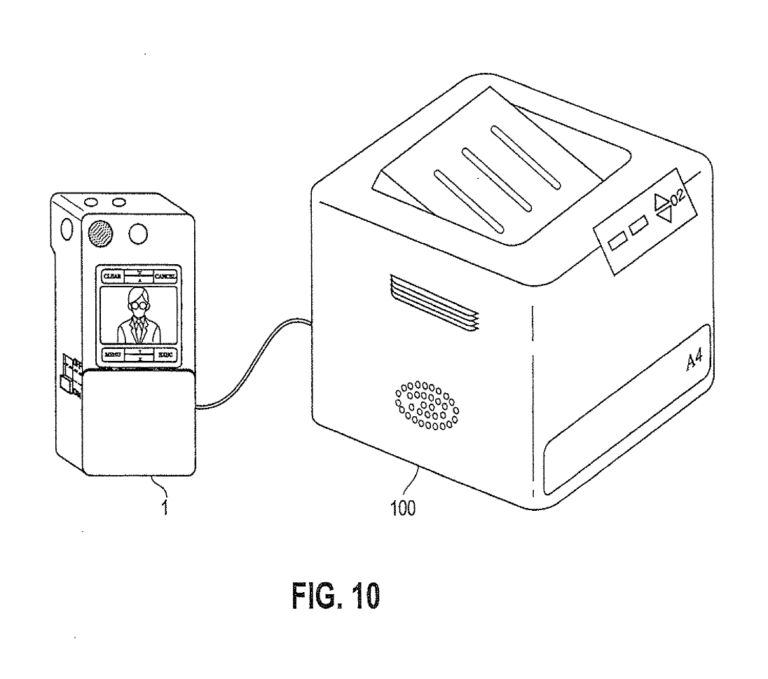

The electronic camera 1 of the present embodiment may be connected to an external printer 100 through the printer connecting terminal 18 as shown in FIG. 10 and the shot image can be printed out on recording paper. As an alternative to a hardwired connection, the camera 1 and printer 100 can be coupled in a wireless fashion, e.g., by infrared or radio wave.

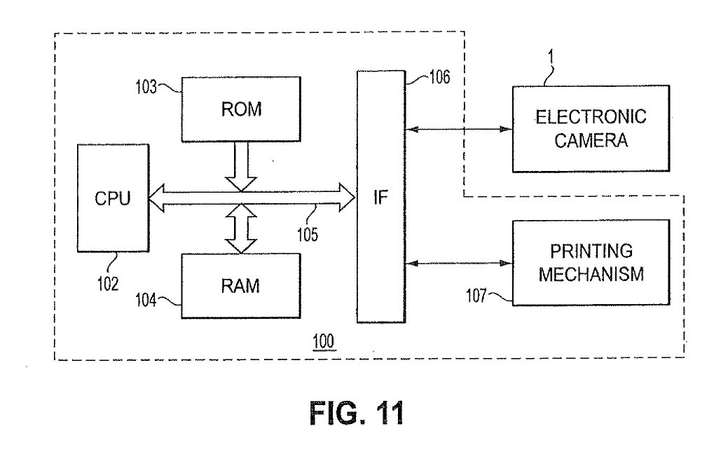

FIG. 11 is a block diagram showing a structural example of the printer 100 shown in FIG. 10. In this figure, CPU 102 performs various processing operations according to programs that are stored in ROM 103. RAM 104 temporarily stores data that is in the middle of being calculated, and programs or the like when CPU 102 performs a specified processing operation. IF (Interface) 106 converts the format of data as needed when CPU 102 sends and receives data to/from an external device. Bus 105 mutually connects the CPU 102, ROM 103, RAM 104, and IF 106, and transmits data between them. IF 106 is connected to an external electronic camera 1 and to a printing mechanism 107 of the printer 100. The printing mechanism 107 prints out image data that has been transmitted from the electronic camera 1, and to which specified processing operations have been performed by CPU 102, on recording paper.

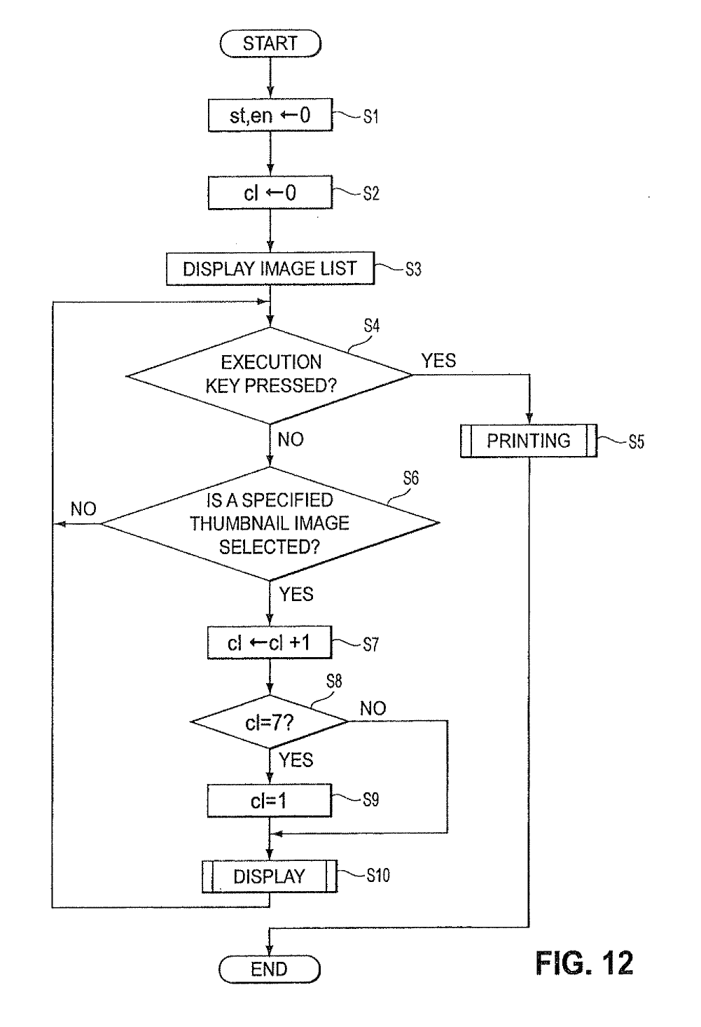

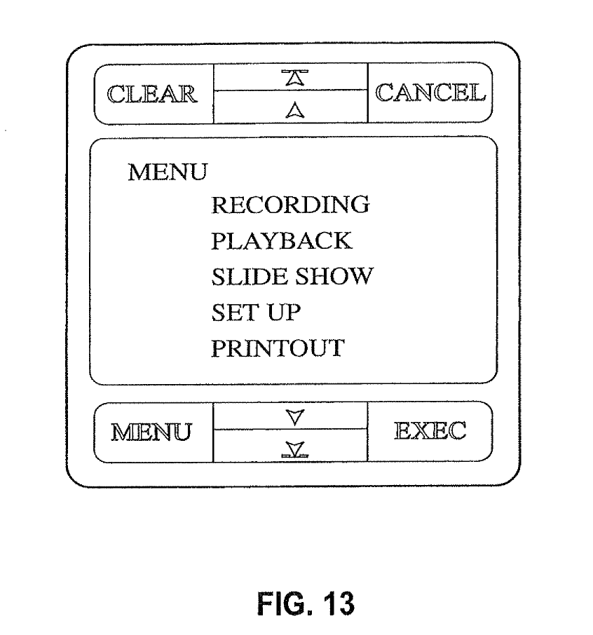

Next, by referring to FIG. 12, one example is explained of processing performed when the printer 100 is connected to the electronic camera 1 of the present embodiment and a shot image is printed out. The processing shown in FIG. 12 is performed when the selection item “PRINT OUT” (printing mode) is selected on the menu screen (see FIG. 13) displayed by pressing the menu key 7A. Furthermore, on the menu screen shown in FIG. 13, as selection items, “RECORDING” (recording mode), “PLAY BACK” (reproduction mode), “SLIDE SHOW” (slide show mode), “SET UP” (set up mode), and “PRINT OUT” (printing mode) are displayed, and it is possible to perform an intended processing by selecting a desired mode among them.

When the processing shown in FIG. 12 is performed, the CPU 39 of the electronic camera 1 initially sets the variable st, which stores the first image ID of an image group to be printed, and the variable en, which stores the final image ID of the image group, respectively, at value 0 in step S1. In step S2, the CPU 39 initially sets the variable cl, which counts the number of times the touch tablet 6A is clicked, at value 0. Then, the program proceeds to step S3. In step S3, the image list (which will be discussed later by referring to FIG. 16) is displayed on the LCD 6. Then, the program proceeds to step S4.

In step S4, the CPU 39 determines whether or not the execution key 7B is pressed. As a result, when it is determined that the execution key 7B is pressed (YES), the program proceeds to step S5, printing processing (which will be discussed later) is performed, and processing is completed (end). When it is determined that the execution key 7B is not pressed (NO), the program proceeds to step S6.

In step S6, the CPU 39 determines whether a specified thumbnail image is clicked (pressed one time) by the pen 41 on the image list shown in FIG. 16. As a result, when it is determined that a specified thumbnail image is not clicked (NO), the program returns to step S4, and the same processing is repeated just as in the case described earlier. When it is determined that a specified thumbnail image is clicked by the pen 41 (YES), the program proceeds to step S7.

In step S7, the value of the variable cl, which counts the number of times clicked, is incremented by 1 and the program proceeds to step S8. In step S8, it is determined whether the value of the variable cl is 7. As a result, when it is determined that the value of the variable cl is not 7 (NO), the program proceeds to step S10. When it is determined that the value of the variable cl is 7 (YES), the program proceeds to step S9. In step S9, the value 1 is assigned to the variable cl, and the program proceeds to step S10.

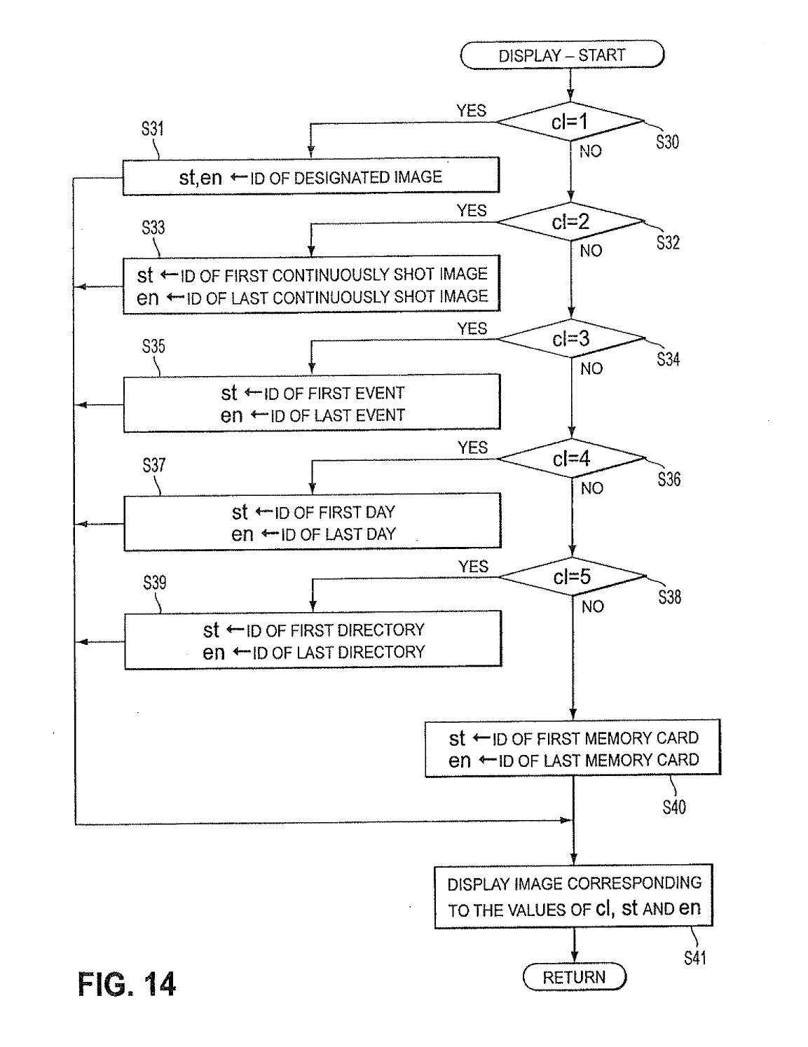

In step S10, the display processing is performed. This processing is a subroutine, and the details will be discussed later by referring to FIG. 14. When the processing of step S10 is completed, the program returns to step S4, and the same processing as in the case described earlier is repeated.

Next, by referring to FIG. 14, details of the display processing shown in step S10 of FIG. 12 are explained. This processing is called and performed when the processing of step S10 of FIG. 12 is performed. When this processing is performed, the CPU 39 determines whether the value of the variable cl is 1 (whether the thumbnail image has been clicked one time) in step S30. As a result, when it is determined that the value of the variable cl is not 1 (NO), the program proceeds to step S32. When it is determined that the value of the variable cl is 1 (YES), the program proceeds to step S31.

In step S31, the first and final image IDs of the image group designated to be printed are inserted to the variables st and en, respectively. Then, the program proceeds to step S41. In step S41, in response to the values of st and en and the variable cl, the image list displayed on the LCD 6 is updated. Further, details will be discussed later.

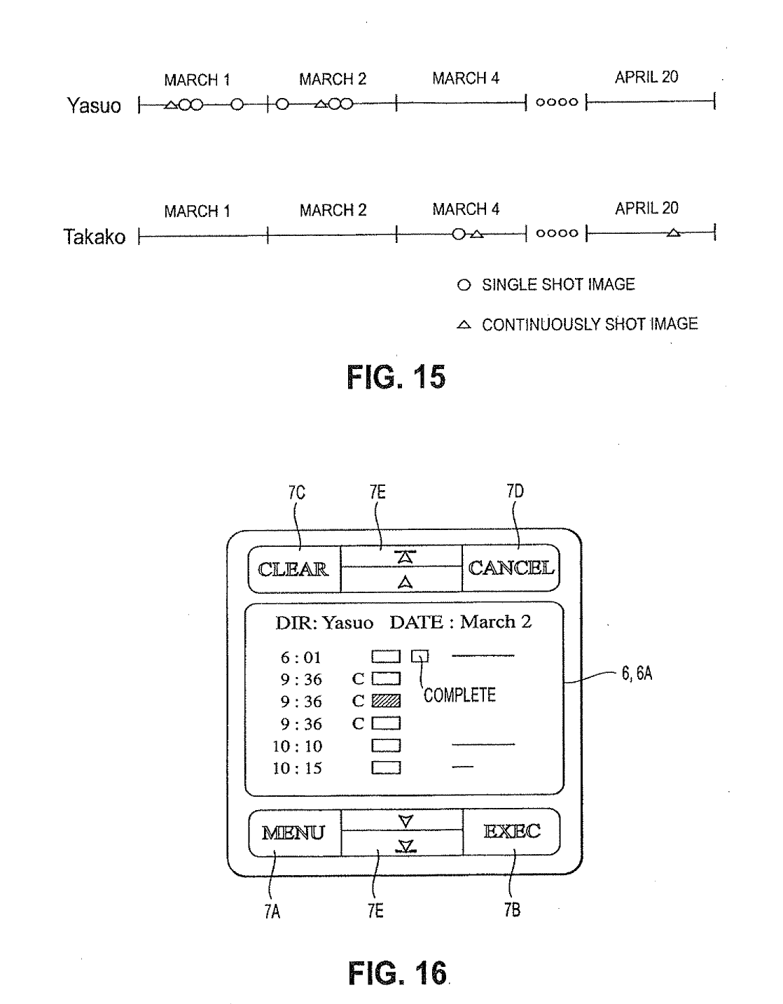

At present, assume, for example, in the memory card 24, as shown in FIG. 15, two directories such as “YASUO” and “TAKAKO” that show user names are formed, and each directory records the images that were shot, respectively, by the two users. Furthermore, in this figure, “◯” represents a single shot image, and “Δ” represents a continuous image. Furthermore, as the IDs of the shot images, for example, the values of 1-99 are sequentially assigned for the shot images that are stored in the directory “YASUO”, and the values of 101-199 are sequentially assigned for the images that are stored in the directory “TAKAKO”.

Additionally, as a list of the shot images, for example, the images that were shot on March 2 that are stored in the directory “YASUO” are displayed on the LCD 6 as shown in FIG. 16. That is, in the example of this figure, an image that was shot at 6:01, three images that were continuously shot at 9:36, and images that were shot at 10:10 and 10:15 are displayed. Furthermore, the character mark “complete” displayed on the right side of the thumbnail image at 6:01 indicates that this image has been printed before (already printed). Additionally, the character mark “C” displayed on the left side of the three thumbnail images that were shot at 9:36 indicates that these are continuous images.

On the list of the shot image like this, for example, if the second image of the continuous image that was shot at 9:36 is clicked by the pen 41, in step S6 of FIG. 12, it is determined that a specified thumbnail image has been clicked (YES), and in step S7, the value of the variable cl is incremented by 1 and cl=1 is established, and the program proceeds to step S10 after going through step S8. When the processing of step S10 is performed, the processing of FIG. 14 is called, and in step S30, because cl=1 is established, the program proceeds to step S31. In step S31, the ID of the designated image is substituted for the variables st and en, respectively. That is, the ID of the clicked image is substituted for the variables st and en, respectively. In step S41 the image list is updated according to the values of the variables st, en, and cl. At the present, cl=1 is established, and the second image ID of the continuous image at 9:36 is stored in the variables st and en. Therefore, in this example, as shown in FIG. 16, the display color of only the designated thumbnail image is changed (this is denoted by cross-hatching of the thumbnail image in FIG. 16). Then, the program returns to the processing of step S4.

Subsequently, if the same thumbnail image is clicked again, the value of the variable cl is incremented by 1 in step S7, and cl=2 is established. As a result, in the processing of FIG. 14, in step S32, it is determined to be YES, and the program proceeds to step S33. In step S33, the IDs of the first and final images of the continuous images to which the image that was first designated (that is, the second image that was continuously shot at 9:36 of FIG. 16) belongs are substituted for the variables st and en, respectively, and the program proceeds to step S41. In step S41, as shown in FIG. 17, the display color of the thumbnails of the three continuous images is changed.

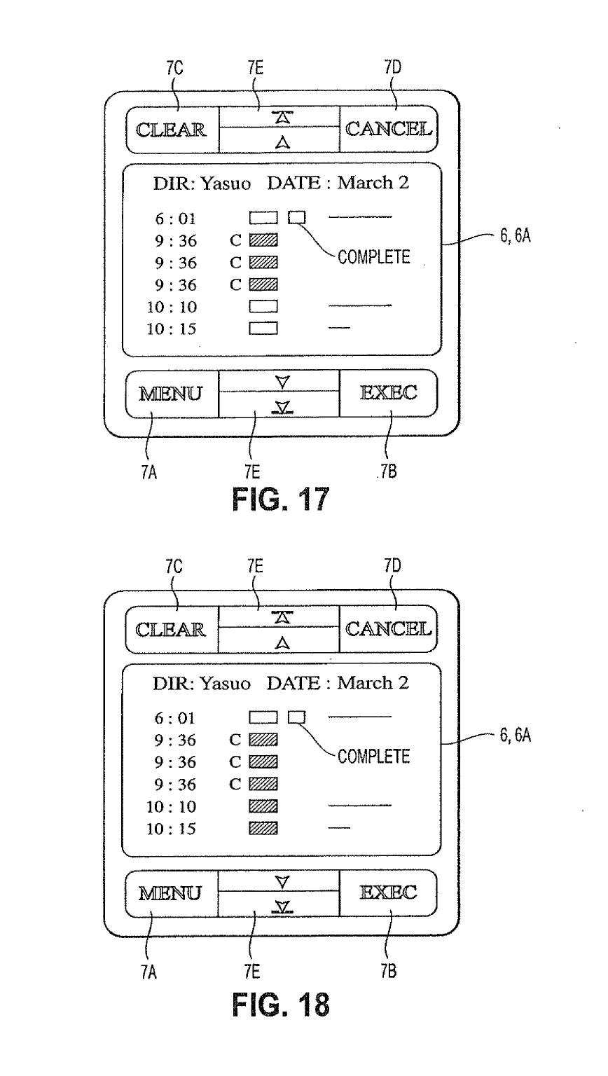

In the same manner, when the thumbnail is clicked again, it is determined to be YES in step S34, and in step S35, the first and final IDs of the event to which the image that was first designated belongs are stored in the variables st and en, respectively, and the program proceeds to step S41. An event is formed according to the difference in shooting times of a certain image and the image immediately before the certain image. That is, when the difference between the shooting times of the certain image and the immediately-preceding image is within a specified time (for example, within one hour), this is considered to be the same event. For example, in the example of FIG. 16, the time differences between the images that were shot at 9:36, 10:10, and 10:15 and the image that was shot immediately before are within one hour, respectively, so that it is considered that all the images belong to the same event. Furthermore, there is more than a one-hour time difference between the image that was shot at 6:01 and the image that was shot immediately after this (the image that was shot at 9:36), so it is considered that they belong to separate events. In the present example, if the continuous image at 9:36 and the images that were shot at 10:10 and 10:15 belong to the same event, in the processing of step S41, as shown in FIG. 18, the display color of the continuous images and the images at 10:10 and 10:15 (the images of the same event) is changed.

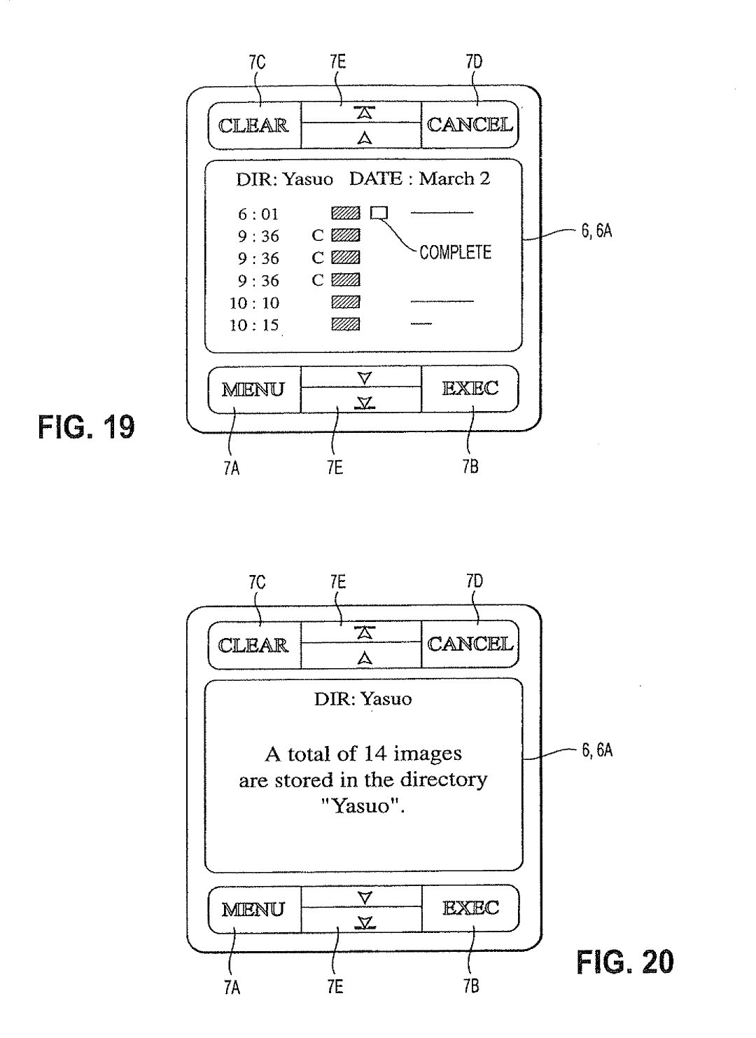

Furthermore, if the thumbnail image is subsequently clicked, in step S36, it is determined to be YES, and the ID of the first image (the image that was shot at 6:01) on the shooting date of the image that was first designated is inserted for the variable st. The ID of the image that was shot last on the same day (the image that was shot at 10:15) is substituted for the variable en. Then, the program proceeds to step S41. In step S41, as shown in FIG. 19, the display color of all the thumbnail images that were shot on March 2 is changed.

Subsequently, if the thumbnail image is again clicked, because cl=5 is established in step S7, it is determined to be YES in step S38, and the program proceeds to step S39. In step S39, the first image ID of the directory and the final image ID of the directory are substituted for the variables st and en, respectively, and the program proceeds to S41.

In step S41, (en−st+1) is calculated and the number of images that are stored in the directory “YASUO” is calculated. Furthermore, when the number of images is more than the number of images that can be displayed on one screen, for example, as shown in FIG. 20, the number of images is displayed. That is, in this display example, in the directory “YASUO”, a total of 14 images are stored.

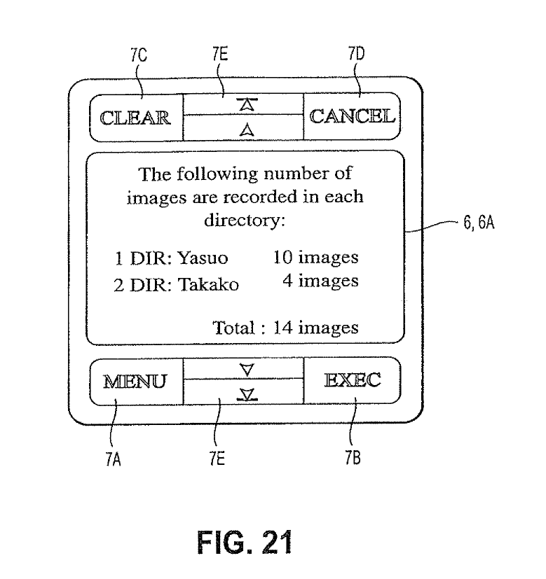

Furthermore, if the thumbnail image is again clicked, in step S7, cl=6 is established and it is determined to be NO in step S38, so the program proceeds to step S40. In step S40, among all the image IDs that are stored in the memory card 24, the minimum and maximum IDs are stored for the variables st and en, respectively, and the program proceeds to step S41. In step S41, as shown in FIG. 21, all the directories that exist in the memory card 24, the number of images that are stored in the respective directories, and the total number of images are displayed. In this display example, 10 images are stored in the directory “YASUO”, and 4 images are stored in the directory “TAKAKO”. It is therefor shown that a total of 14 images are stored.

When the thumbnail image is again clicked, cl=7 is established, and it is determined to be YES in step S8 and cl=1 is established in step S9, so the program will return to the display of FIG. 16.

Therefore, in order to summarize the operation of the above embodiment, the images that are recorded in the memory card 24 (recording means) can be considered to have a hierarchical structure according to the time, date and event (attribute information) at which the images are recorded. That is, the top level of the hierarchy is divided by directory and, for example, it is assigned to each user. Furthermore, the hierarchy level below the top hierarchy level is divided by recording date. Furthermore, the hierarchy level below this is divided by event, which is determined by referring to the time difference between the shooting times of a certain image and the immediately-preceding image, as described earlier. Additionally, the hierarchy level below this is divided by continuous image. In addition, when a designated thumbnail image is clicked by the pen 41 (shifting means), according to the number of clicks, the hierarchy that is the object of printing is shifted toward the top and the display color of all the images included in the hierarchy is consecutively changed.

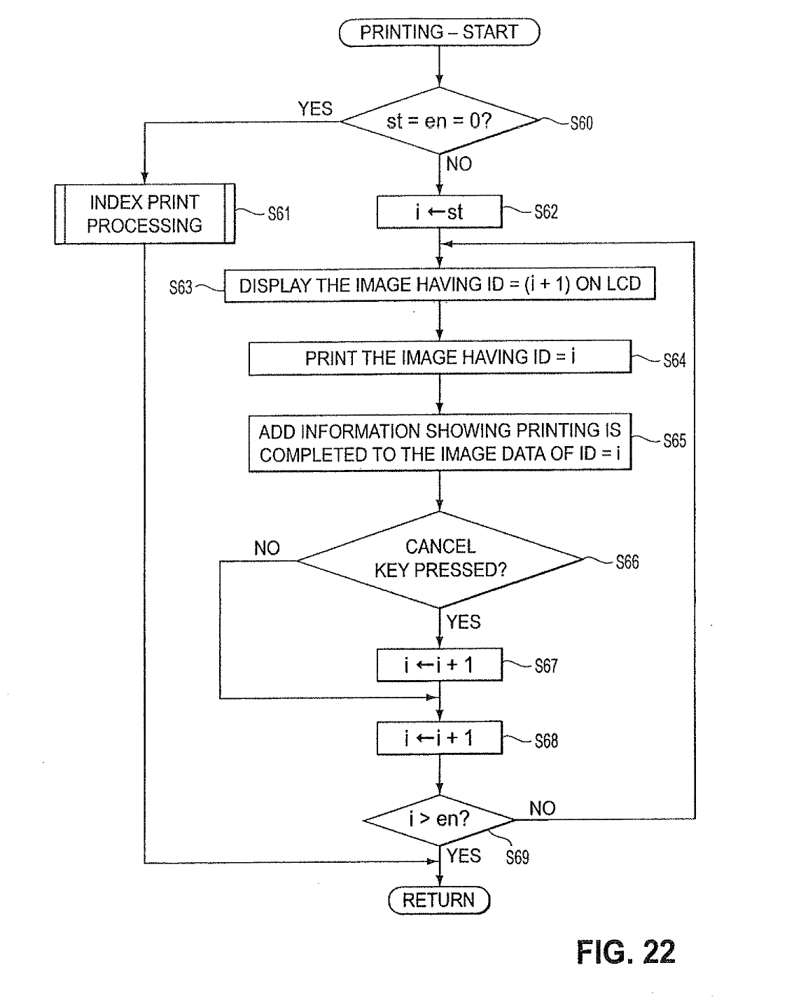

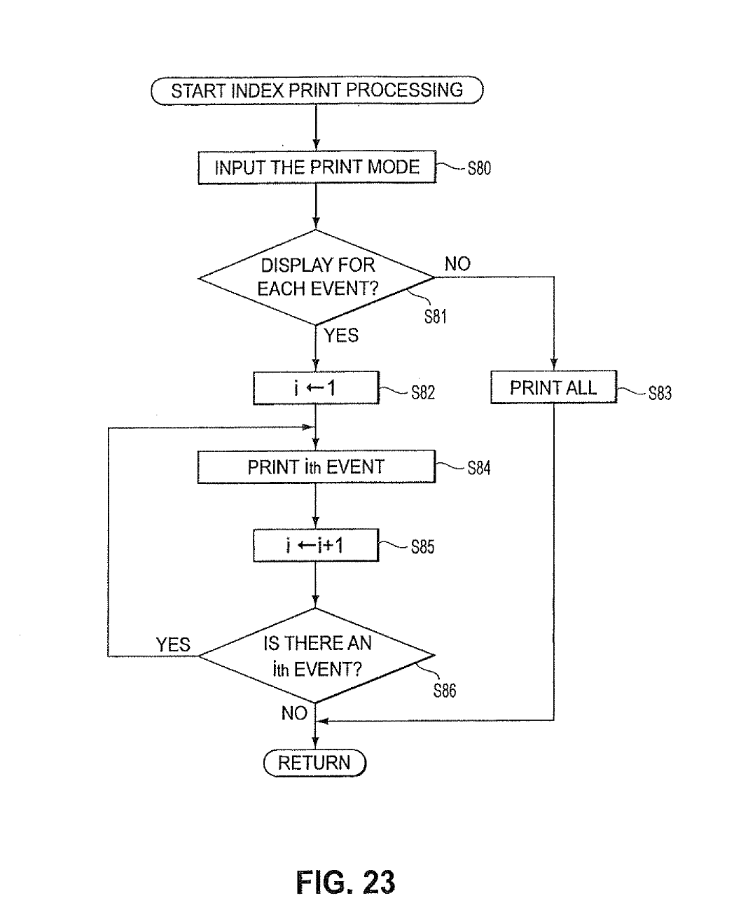

Here, when images in a specified hierarchy are displayed, if the execution key 7B is pressed, it is determined to be YES in step S4, the program proceeds to step S5, and printing processing of the selected image(s) is (are) executed. Subsequently, by referring to FIGS. 22 and 23, details of the processing of step S5 are explained.

When this processing is executed, in step S60, the CPU 39 determines whether the values of the variables st and en are both 0 (whether or not the execution key 7B is pressed without clicking on any thumbnails). As a result, when it is determined that the values of st and en are both 0 (YES), the program proceeds to step S61. In step S61, the designated image is reduced, and index printing processing, which prints the image on a sheet of recording paper, is executed. Further details of this processing will be described later by referring to FIG. 23.

In step S60, when it is determined that the values of the variables st and en are not both 0 (NO), the program proceeds to step S62. In step S62, the value of the variable st, that is, the ID of the first image to be printed, is substituted for the variable i and the program proceeds to step S63.

In step S63, after the CPU 39 reads the image with the ID in which 1 is added to the value of the variable i from the memory card 24 and performs decompression processing, the image is displayed on the LCD 6. As a result, the image to be subsequently printed (a next image) is displayed on the LCD 6. Furthermore, if the value in which 1 is added to the value of the variable i is larger than the value of the variable en, the display processing is not performed.

In step S64, after the CPU 39 reads the image with the value of the variable i (the first image) as ID from the memory card 24 and performs decompression processing, the image (the first image) is output to the printer 100 through the interface 48. After the printer 100 receives the image data output from the electronic camera 1 via the IF 106 and temporarily stores it in RAM 104, the image data is output to the printing mechanism 107. As a result, an image corresponding to the image data is printed on recording paper.

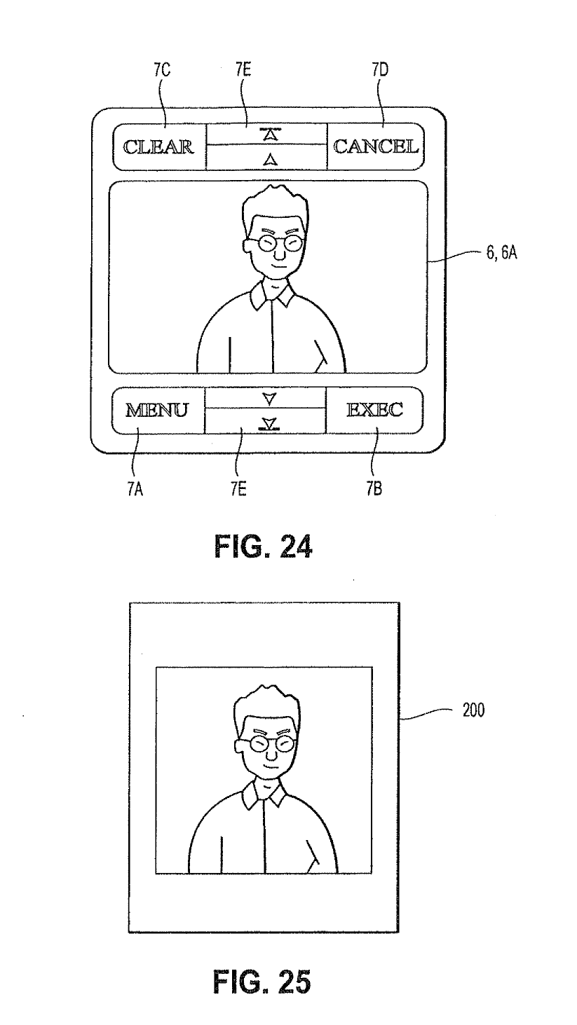

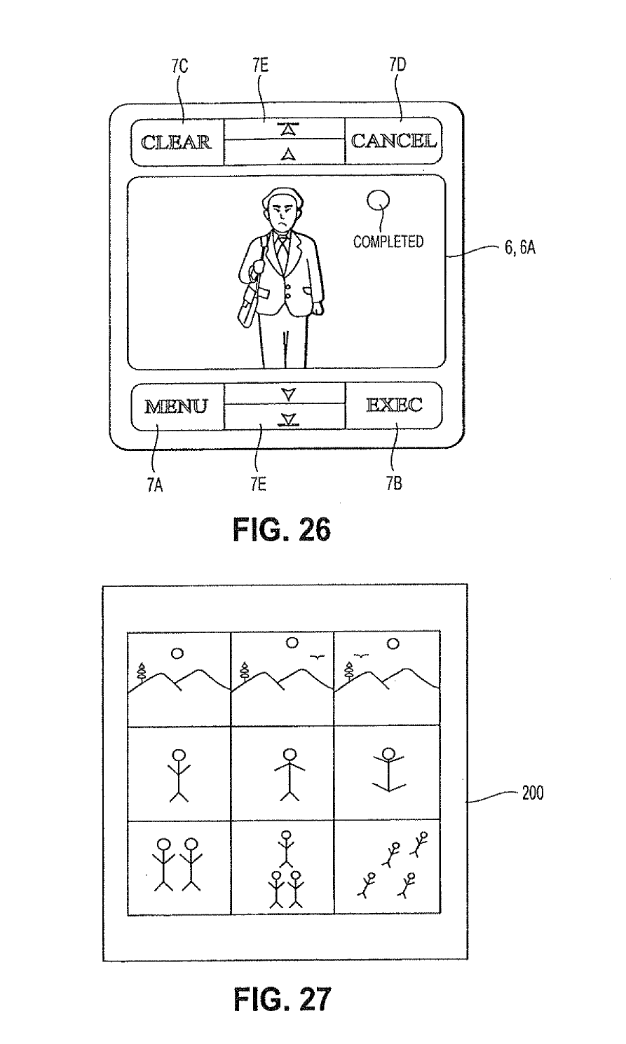

At present, if a certain image (the first image) is being printed and the image shown in FIG. 24 (the next image) is displayed on the LCD 6, when the image printing (of the first image) is completed as described earlier, the image displayed on the LCD 6 (the next image) is subsequently printed. FIG. 25 is a diagram showing a printing example when the image shown in FIG. 24 is printed on recording paper 200. Furthermore, when the image to be subsequently printed is an image that has already been printed (an image to which the already-printed information is added), as shown in FIG. 26 a character mark of “completed” indicating that the image has been already printed is displayed on part of the screen.

In step S65, the already-printed information is added to the image for which printing is completed (image of ID=i). The already-printed information is stored in, for example, a specified bit of the header of each image, and when this bit is in a state of “1”, it indicates that it has already been printed. Thus, when the image in which the already-printed information is added is displayed on the list, just like the image that was shot at 6:01 of FIG. 16, a mark is displayed showing that it has already been printed. Furthermore, when index printing is performed, in which a plurality of images are recorded on a single sheet of recording paper (printing in step S61 which will be discussed later), the already-printed information is not added.

In step S66, the CPU 39 determines whether the cancel key 7D is pressed. As a result, when it is determined that the cancel key 7D is not pressed (NO), the program proceeds to step S68. When it is determined that the cancel key 7D is pressed (YES), the program proceeds to step S67. In step S66, when it is determined to be YES, the program proceeds to step S67, the value of the variable i is incremented by 1, and the program proceeds to step S68. Also, in step S68, the value of the variable i is incremented by 1 and the program proceeds to step S69.

In step S69, it is determined whether the value of the variable i is larger than the value of the variable en. As a result, when it is determined that the value of i is larger than the value of en (YES), the processing is completed (END). In addition, when it is determined that the value of i is less than the value of en (NO), the program returns to step S63 and the same processing is repeated as in the case described earlier.

According to the above processing, when the values of the variables st and en are both 0, the index printing, which will be discussed later, is performed, and in cases other than this, the image group with the ID that is designated by the variables st and en is printed out. Furthermore, at this time, because the image that will subsequently be printed out (the next image) is displayed on the LCD 6, it is possible to confirm the image prior to printing out, and if the image is not needed, the printing of that image can be canceled by pressing the cancel key 7D.

Next, by referring to FIG. 23, details of the index printing processing shown in step S61 are explained. When this processing is performed, in step S80, the CPU 39 receives the input of the printing mode. That is, the user selects whether the image should be printed on a sheet of recording paper by event, or whether all the images should be printed on one sheet of paper. Furthermore, to distinguish the type of printing, when the execution key 7B is single-clicked, all the images are printed on a sheet of recording paper and when the execution key 7B is double-clicked, one event is recorded per sheet of recording paper.

In step S81, the CPU 39 determines whether the display is designated by event in step S80. As a result, when it is determined that the display is not designated by event (NO), the program proceeds to step S83. After all the images that are recorded in the memory card 24 are read and decompression processing is performed, each image is reduced according to the size of the recording paper and the number of images by thinning out each image, and the images are composed into one image and are output to the printer 100. As a result, for example, the image shown in FIG. 27 is printed.

Furthermore, thumbnail images, for example, can be used for the images that are created by the thinning processing. In addition, when all the images cannot be recorded on one sheet of recording paper, it is acceptable to print the images by dividing them onto a plurality of sheets of recording paper.

Furthermore, in step S81, when it is determined that printing by event is designated (YES), the program proceeds to step S82. In step S82, the variable i is initially set at 1. Then, the program proceeds to step S84. In step S84, after the CPU 39 reads the image group that belongs to the ith event from the memory card 24 and performs decompression processing, according to the number of images and the size of the recording paper, the pixels are thinned out and the images are reduced, and the images are combined and made into one image. Furthermore, this image is output to the printer 100 through the interface 48. As a result, the printer 100 prints so as to record each event on a single sheet of recording paper.

In step S85, the value of the variable i is incremented by 1 and the program proceeds to step S86.

In step S86, the CPU 39 determines whether the ith event exists. As a result, when it is determined that the ith event exists (YES), the program proceeds to step S84, and the same processing is repeated as in the case described earlier. Furthermore, when it is determined that the ith event does not exist (NO), the program returns to the original processing.

According to the above processing, according to the number of times clicked, a hierarchy is selected for printing, and all the images included under the hierarchy are printed, so it is possible to perform printing processing that reflects the mutual relationships of the images. Furthermore, in the above embodiment, the image list is first displayed and shifting is made toward the top hierarchy according to the number of clicks.

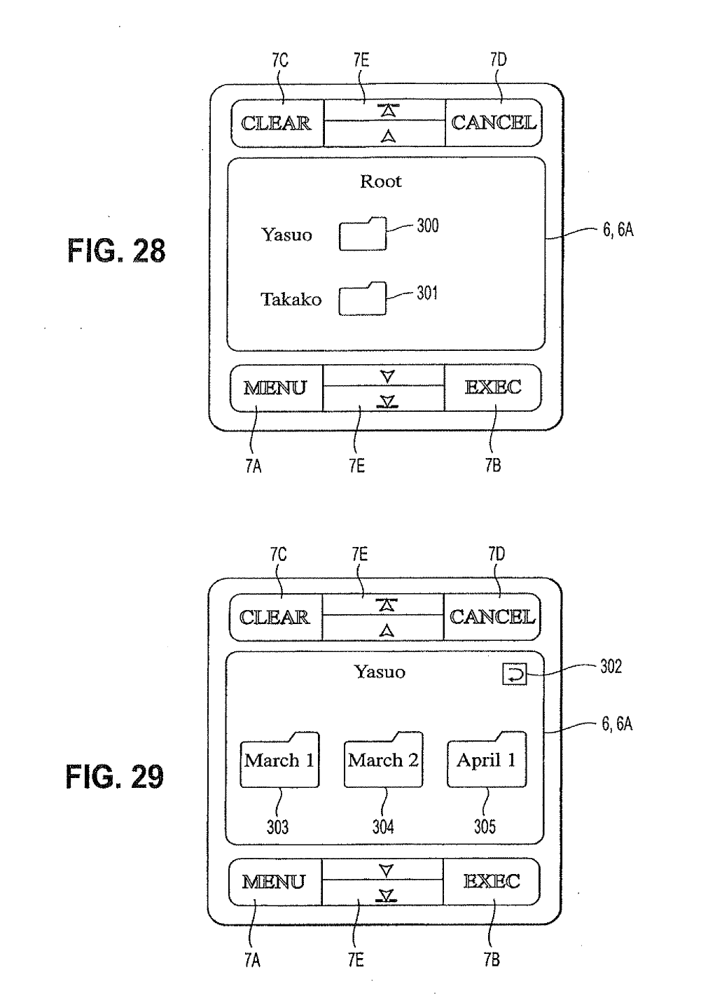

Alternatively, for example, it is also acceptable to gradually move the hierarchy to the base hierarchy after designating the top hierarchy. FIGS. 28-31 are diagrams showing display examples of such a format.

FIG. 28 is a display example of when the selection item “PRINT OUT” is selected on the menu screen of FIG. 13. In this example, file folders 300 and 301 showing the directories “YASUO” and “TAKAKO”, respectively, are displayed. On this type of display screen, for example, if a double click is made by the pen 41 (the touch tablet 6A is consecutively pressed twice on the file folder 300 (YASUO), the screen shown in FIG. 29 is subsequently displayed. In this display example, file folders 303-305 in which images shot on March 1, March 2, and April 1 are stored are displayed. Furthermore, at the upper right corner of the figure, a return button 302 is displayed that is operated when the image is returned to the screen of FIG. 28.

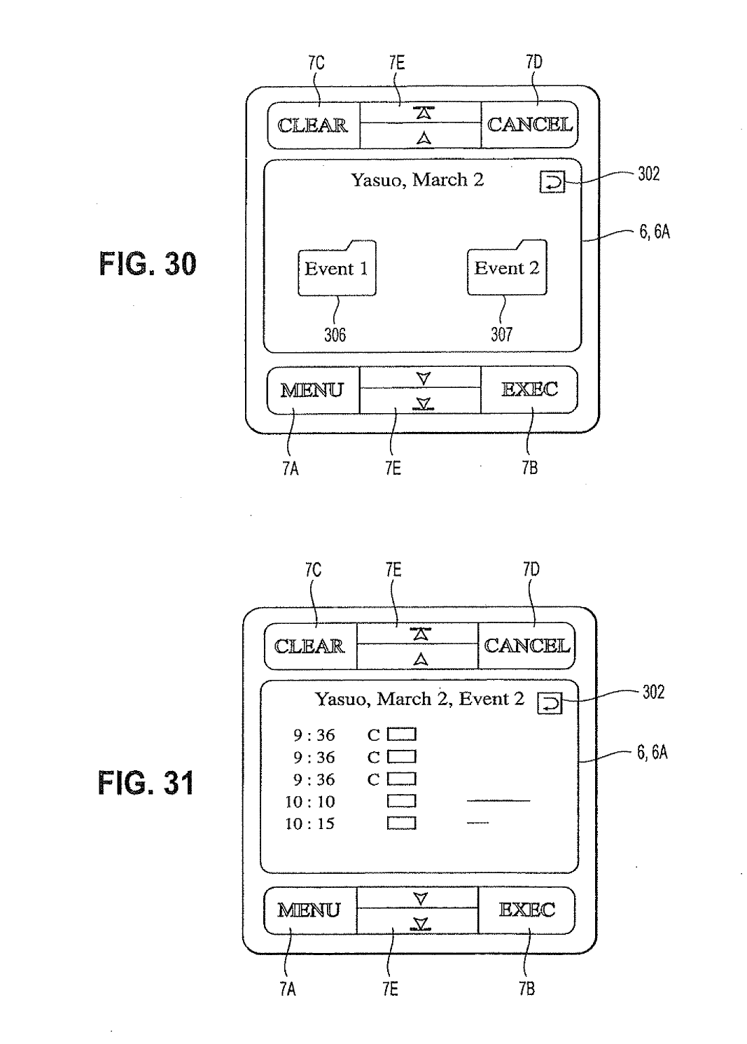

Subsequently, on the display screen of FIG. 29, when there is a double click on the file folder 304 of March 2, the file folders 306 and 307 for the events 1 and 2 included on March 2 are displayed as shown in FIG. 30. Furthermore, in this figure, the return button 302 is operated when the image is to be returned to the screen of FIG. 29. On the display screen of FIG. 30, when there is a double click on the file folder 307 corresponding to the event 2, the screen shown in FIG. 31 is displayed. On this screen, thumbnail images corresponding to the image included in the event 2 are displayed. In this example, thumbnail images are displayed corresponding to the continuous images that were shot at 9:36 and the images that were shot at 10:10 and 10:15.

In the above display, when the user performs a single click on a specified file folder or a thumbnail and presses the execution key 7B, all the images included in the designated file folder are printed. For example, on the display screen of FIG. 30, after a single click is made on the file folder 307, and the execution key 7B is pressed, all the shot images shown in FIG. 31 are consecutively output from the interface 48 and printed.

Furthermore, the display examples of the above embodiment are only one example, and, needless to say, the present invention is not limited to these display examples. For example, other interfaces are possible.

In the described embodiment, images and attributes (file name, recording dates and times) of the images are stored in association with the images in memory. One or more images are designated (for output such as, for example, printing) by touching (clicking) a thumbnail of the image (or some symbol representative of that image, such as a file icon or date icon) and by determining the number of times touching (clicking) is performed. This identifies a hierarchy level and images associated with that level. The final selection is confirmed by pressing the execution key 7, although this also could be based on expiration of a time period (e.g., since a last click) or a different switch actuation. It is not necessary to click on the same thumbnail each time. For example, any clicking on the display can be used once a first thumbnail is clicked in the example of FIGS. 16-21.

The invention is not limited to the disclosed example in which a touch tablet and pen are used to designate an image and shift within the hierarchy. For example, a light pen or a finger can be used with a touch tablet. Selection can be made by means other than a touch tablet. A cursor moved by a mouse, trackball or touch pad could be used, for example. The movement of a cursor and/or clicking/shifting function can be performed from a remote input.

Furthermore, in the above embodiment, printing is done in order from the images with the smallest ID. However, for example, it is also acceptable to print the images according to the shooting time and date or updated time and date.

In the described embodiment, the control programs shown in FIGS. 12, 14, 22, and 23 are stored in the memory card 24. These programs can be supplied to the user in a state of being stored in the memory card 24 in advance. Alternatively, the programs can be supplied to the user using a CD-ROM (Compact Disk ROM) or the like in a state where the programs can be copied to the memory card 24. The control programs also can be supplied as a data signal embodied in a carrier wave transmitted to the camera over a communications system. The programs also can be stored in a memory other than the memory card 24.

Thus, the invention further includes, as another aspect, a control program that includes instructions for use by a controller of an electronic camera so as to cause the electronic camera to function as detailed above. The control program can be recorded in a transient computer-readable recording medium such as a carrier wave. The control program can be transmitted as a data signal embodied in the carrier wave. The data signal can be transmitted over a communications system such as, for example, the World Wide Web. The data signal also can be transmitted in a wireless fashion, for example, by radio waves or by infrared waves. The control program can be stored in a more permanent computer-readable recording medium, such as, for example, a CD-ROM, a computer hard drive, RAM, or other types of memories that are readily removable or intended to remain fixed within the computer. As noted earlier, a memory card 24 storing the control program is illustrated in FIG. 6.

In the illustrated embodiment, the electronic camera controller (CPU 39) is implemented using a suitably programmed general purpose computer, e.g., a microprocessor, microcontroller or other processor device (CPU or MPU). It will be appreciated by those skilled in the art, that the controller can also be implemented as a single special purpose integrated circuit (e.g., ASIC) having a main or central processor section for overall, system-level control, and separate sections dedicated to performing various different specific computations, functions and other processes under control of the central processor section. The controller can also be implemented using a plurality of separate dedicated or programmable integrated or other electronic circuits or devices (e.g., hardwired electronic or logic circuits such as discrete element circuits, or programmable logic devices such as PLDs, PLAs, PALs or the like). The controller can also be implemented using a suitably programmed general purpose computer in conjunction with one or more peripheral (e.g., integrated circuit) data and signal processing devices. In general, any device or assembly of devices on which a finite state machine capable of implementing the flow charts shown in FIGS. 12, 14, 22 and 23 can be used as the controller.

While the present invention has been described with reference to preferred embodiments thereof, it is to be understood that the invention is not limited to the disclosed embodiments or constructions. To the contrary, the invention is intended to cover various modifications and equivalent arrangements. In addition, while the various elements of the disclosed invention are shown in various combinations and configurations, which are exemplary, other combinations and configurations, including more, less or only a single element, are also within the spirit and scope of the invention.

What is claimed is:

1. An information processing device, comprising:
a memory in which is recorded image data and attribute information of the image data, the attribute information having a hierarchy with plural levels;
designation means for designating image data as selectable image data from among the image data recorded in the memory;
shifting means, responsive to the designation means, for shifting a hierarchy level of the selectable image data upward or downward; and
selection means for selecting image data from the image data recorded in the memory, the selected image data being the selectable image data included in the hierarchy level shifted to by the shifting means.

2. The information processing device of claim 1, further comprising output means for outputting the selected image data to an external device.

3. The information processing device of claim 2, wherein the external device is a printer.

4. The information processing device of claim 3, wherein the output means outputs to the printer so that the selected image data is printed out on a specified number of recording sheets.

5. The information processing device of claim 2, wherein the output means outputs the selected image data in order to the external device according to a recording date of the image data.

6. The information processing device of claim 1, wherein the hierarchy is formed based upon recording dates of the image data, the recording dates being at least part of the attribute information.

7. The information processing device of claim 6, wherein all image data recorded within a specified time interval is included in one hierarchy level.

8. The information processing device of claim 1, wherein the hierarchy is formed based upon a predetermined condition.

9. The information processing device of claim 8, wherein at least one said predetermined condition is a user name, such that one level of the hierarchy is the user name.

10. The information processing device of claim 1, wherein the information processing device is an electronic camera.

11. The information processing device of claim 1, wherein the shifting means is responsive to successive actuation of the designation means.

12. The information processing device of claim 1, wherein the image data designated by the designation means is at least one image.

13. An information processing method, comprising the steps of:
recording image data and attribute information associated with the image data in memory, the attribute information having a hierarchy with plural levels;
designating image data, from among the image data recorded in the memory, as selectable image data;
shifting a hierarchy level of the selectable image data upward or downward; and
selecting the selectable image data included in the shifted-to hierarchy level.

14. A computer readable storage medium being encoded with a computer readable control program that comprises:
a recording procedure that records image data and attribute information associated with the image data in memory, the attribute information having a hierarchy with plural levels;
a designation procedure that designates image data, from among the image data recorded in the memory, as selectable image data;
a shifting procedure that shifts a hierarchy level of the selectable image data upward or downward; and
a selection procedure that selects the selectable image data included in the shifted-to hierarchy level.

15. An information processing device, comprising:
a memory in which is recorded image data;
read-out means for reading out the image data from the memory;
setting means for setting a printing condition by which to print the image data on a recording sheet when the read-out image data is output to a printer by the read-out means;
output means for outputting the image data set by the setting means to the printer; and
adding means for adding additional information, indicating that the printing has been performed, to the image data for which the printing has been completed by the printer according to the printing condition set by the setting means.

16. The information processing device of claim 15, wherein the adding means does not add the additional information when the printing condition set by the setting means is to print a plurality of images on one recording sheet.

17. An information processing method, comprising the steps of:
recording image data in memory;
reading out selected image data recorded in the memory;
setting a printing condition for printing the selected image data on a recording sheet when the selected image data is read-out from the memory to a printer;
outputting the selected image data set at the setting step to the printer; and
adding additional information, indicating that printing has been performed, to the image data for which the printing has been completed by the printer according to the printing condition set by the setting step.

18. A computer readable storage medium being encoded with a computer readable control program that comprises:
a recording procedure that records image data in memory;
a read-out procedure that reads out selected image data recorded in the memory;
a setting procedure that sets a printing condition for printing the selected image data on a recording sheet when the selected image data is read-out from the memory to a printer;
an output procedure that outputs the selected image data set by the setting procedure to the printer; and
an adding procedure that outputs additional information, indicating that printing has been performed, to the image data for which the printing has been completed by the printer according to the printing condition set by the setting procedure.

19. An image processing device, comprising:
a memory in which is recorded a plurality of image data;
read-out means for reading out selected image data recorded in the memory.
a display;
first output means for outputting the image data read-out by the read-out means to an external device; and
second output means for outputting at least one image data, output after the image data output by the first output means, to the display.

20. The information processing device of claim 19, further comprising stopping means for stopping the output of the at least one image data, displayed on the display, to the first outputting means.

21. The information processing device of claim 19, wherein the external device is a printer.

22. The information processing device of claim 19, wherein the second output means outputs the at least one image data immediately after the image data that is output by the first output means.

23. An information processing method, comprising the steps of
recording a plurality of image data in memory;
reading out selected image data recorded in the memory;
first outputting the image data read out in the reading out step to an external device; and
second outputting at least one image data, output after the image data that is output in the first output step, to a display that is different from the external device.

24. A computer readable storage medium being encoded with a computer readable control program that comprises:
a recording procedure that records a plurality of image data in memory;
a read-out procedure that reads out selected image data recorded in the memory;
a first output procedure that outputs the image data read-out by the read-out procedure to an external device; and
a second output procedure that outputs at least one image data, output after the image data that is output by the first output procedure, to a display that is different from the external device.

25. An information processing device, comprising:
a memory in which is recorded a plurality of image data;
output means for outputting a selected plurality of the image data recorded in the memory to a printer; and
selection means for selecting whether to print the selected plurality of image data output by the output means on one recording sheet or to print one image data per one recording sheet.

26. An information processing method, comprising the steps of:
recording a plurality of image data in memory;
outputting a selected plurality of image data recorded in the memory to a printer; and
selecting whether to print the selected plurality of image data output by the outputting step per one recording sheet or to print one image data per one recording sheet.

27. A computer readable storage medium being encoded with a computer readable control program that comprises:
a recording procedure that records a plurality of image data in memory;
an output procedure that outputs a selected plurality of image data recorded in the memory to a printer; and
a selecting procedure that selects whether to print the selected plurality of image data output by the output procedure on one recording sheet or to print one image data per one recording sheet.
